(19) United States
(12) Patent Application Publication
(10) Pub. No.: US 2026/0129603 A1
(43) Pub. Date: May 7, 2026

(54) TERMINAL AND POSITIONING METHOD

(71) Applicant: NTT DOCOMO, INC., Tokyo (JP)

(72) Inventors: Shohei Yoshioka, Chiyoda-ku, Tokyo (JP); Taichi Shichijo, Chiyoda-ku, Tokyo (JP); Satoshi Nagata, Chiyoda-ku, Tokyo (JP)

(73) Assignee: NTT DOCOMO, INC., Tokyo (JP)

(21) Appl. No.: 19/117,536

(22) PCT Filed: Aug. 28, 2023
(86) PCT No.: PCT/JP2023/030861

§ 371 Date: Apr. 1, 2025

(30) Foreign Application Priority Data
Oct. 14, 2022 (JP) 2022-165796

(51) Int. Cl. H04W 64/00; H04W 24/10; H04W 76/14

(52) U.S. Cl. CPC H04W 64/00; H04W 24/10; H04W 76/14

(57) ABSTRACT

A terminal includes: a reception unit configured to receive a signal related to positioning in device-to-device direct communication from a terminal in a first resource pool; a control unit configured to perform measurement based on the signal related to positioning in the device-to-device direct communication; and a transmission unit configured to transmit information based on the measurement to the terminal in a second resource pool. The control unit determines the first resource pool and the second resource pool.

### FIELD OF THE INVENTION

The present invention relates to a terminal and a positioning method in a wireless communication system.

### BACKGROUND OF THE INVENTION

In LTE (Long Term Evolution) and LTE successor systems (e.g., LTE-A (LTE Advanced), NR (New Radio) (also referred to as 5G)), a D2D (Device to Device) technology in which terminals communicate directly with each other without using a base station is being discussed (e.g., Non-Patent Document 1).

The D2D reduces traffic between the terminals and the base stations and enables communication between the terminals even when the base stations are unable to communicate during a disaster, etc. Although the 3GPP (registered trademark) (3rd Generation Partnership Project) refers to D2D as a “sidelink”, the more generic term D2D is used herein. However, in the description of embodiments described below, sidelink is also used as needed.

The D2D communication is broadly classified into: D2D discovery for discovering other terminals capable of communication; and D2D communication (D2D direct communication, device to device direct communication, etc.) for direct communication between terminals. Hereinafter, when D2D communication and D2D discovery are not specifically distinguished, it is simply called D2D. A signal sent and received by D2D is called a D2D signal. Various use cases of V2X (Vehicle to Everything) services in NR have been discussed (e.g., Non-Patent Document 2).

### CITATION LIST

Non-Patent Document
Non-Patent Document 1:3GPP TS 38.211 V 17.3.0 (2022-09)
Non-Patent Document 2:3GPP TR 22.886 V 16.2.0 (2018-12)
Non-Patent Document 3:3GPP TS 38.305 V 17.2.0 (2022-09)
Non-Patent Document 4:3GPP TS 38.455 V 17.2.0 (2022-09)
Non-Patent Document 5:3GPP TS 37.355 V 17.2.0 (2022-09)
Non-Patent Document 6:3GPP TS 23.032 V 17.2.0 (2021-12)
Non-Patent Document 7:3GPP TS 38.215 V 17.2.0 (2022-09)

### SUMMARY OF THE INVENTION

### Technical Problem

The positioning is being discussed in the scenarios of the device-to-device direct communications, such as in-coverage, partial-coverage, out-of-coverage, V2X (Vehicle to Everything), public safety, commercial, IIOT (Industrial Internet of Things), or the like. Here, when reporting the measurement result by receiving the positioning reference signal in the device-to-device direct communication, there is a case in which the measurement result cannot be reported in a resource pool in which the reference signal is received.

The present invention has been made in view of the above points, and it is an object of the present invention to report the measurement result of the positioning reference signal in the device-to-device direct communication.

### Solution to Problem

According to the disclosed technique, a terminal is provided. The terminal includes: a reception unit configured to receive a signal related to positioning in device-to-device direct communication from a terminal in a first resource pool; a control unit configured to perform measurement based on the signal related to positioning in the device-to-device direct communication; and a transmission unit configured to transmit information based on the measurement to the terminal in a second resource pool. The control unit determines the first resource pool and the second resource pool.

### ADVANTAGEOUS EFFECTS OF INVENTION

According to the disclosed technique, the measurement result of the positioning reference signal in the device-to-device direct communication can be reported.

### BRIEF DESCRIPTION OF THE DRAWINGS

FIG. 1 is a drawing for describing a wireless communication system.

FIG. 2 is a drawing for describing V2X.

FIG. 3 is a drawing for describing an example of communication in D2D.

FIG. 4 is a drawing illustrating an example (1) of positioning.

FIG. 5 is a drawing illustrating an example of measuring DL-RSTD.

FIG. 6 is a drawing illustrating an example of measuring UL-RTOA.

FIG. 7 is a drawing illustrating an example (2) of positioning.

FIG. 8 is a drawing illustrating an example of measuring RTT.

FIG. 9 is a flowchart for describing an example (1) of position estimation related to an embodiment of the present invention.

FIG. 10 is a drawing for describing an example (1) of position estimation related to an embodiment of the present invention.

FIG. 11 is a drawing illustrating an example of the arrangement of the reference signal in an embodiment of the present invention.

FIG. 12 is a flowchart for describing an example (2) of position estimation related to an embodiment of the present invention.

FIG. 13 is a drawing for describing an example (2) of position estimation related to an embodiment of the present invention.

FIG. 14 is a flowchart for describing an example (3) of position estimation related to an embodiment of the present invention.

FIG. 15 is a drawing for describing an example (3) of position estimation related to an embodiment of the present invention.

FIG. 16 is a flowchart for describing an example (4) of position estimation related to an embodiment of the present invention.

FIG. 17 is a drawing for describing an example (4) of position estimation related to an embodiment of the present invention.

FIG. 18 is a flowchart for describing an example (5) of position estimation related to an embodiment of the present invention.

FIG. 19 is a drawing for describing an example (5) of position estimation related to an embodiment of the present invention.

FIG. 20 is a drawing illustrating an example (1) of a resource pool related to an embodiment of the present invention.

FIG. 21 is a drawing illustrating an example (2) of a resource pool related to an embodiment of the present invention.

FIG. 22 is a sequence diagram for describing an example (1) of reporting the measurement result in an embodiment of the present invention.

FIG. 23 is a sequence diagram for describing an example (2) of reporting the measurement result in an embodiment of the present invention.

FIG. 24 is a drawing illustrating an example of a functional configuration of a base station 10 in an embodiment of the present invention.

FIG. 25 is a drawing illustrating an example of a functional configuration of a terminal 20 in an embodiment of the present invention.

FIG. 26 is a drawing illustrating an example of a hardware structure of the base station 10 or the terminal 20 in an embodiment of the present invention.

FIG. 27 is a drawing illustrating an example of a structure of a vehicle 2001 in an embodiment of the present invention.

### DETAILED DESCRIPTION OF THE PREFERRED EMBODIMENTS

In the following, while referring to the drawings, one or more embodiments of the present invention will be described. It should be noted that the embodiments described below are examples. Embodiments of the present invention are not limited to the following embodiments.

In operations of a wireless communication system according to an embodiment of the present invention, a conventional technique will be used when it is appropriate. With respect to the above, for example, the conventional techniques are related to, but not limited to, the existing LTE. Further, it is assumed that the term “LTE” used in the present specification has, unless otherwise specifically mentioned, a broad meaning including a scheme of LTE-Advanced and a scheme after LTE-Advanced (e.g., NR), or wireless LAN (Local Area Network).

In addition, in an embodiment of the present invention, the duplex method may be a TDD (Time Division Duplex) method, an FDD (Frequency Division Duplex) method, or any other method (e.g., Flexible Duplex, or the like).

Further, in an embodiment of the present invention, the expression, radio (wireless) parameters are “configured (set)” may mean that a predetermined value is pre-configured, or may mean that a radio parameter indicated by a base station 10 or a terminal 20 is configured.

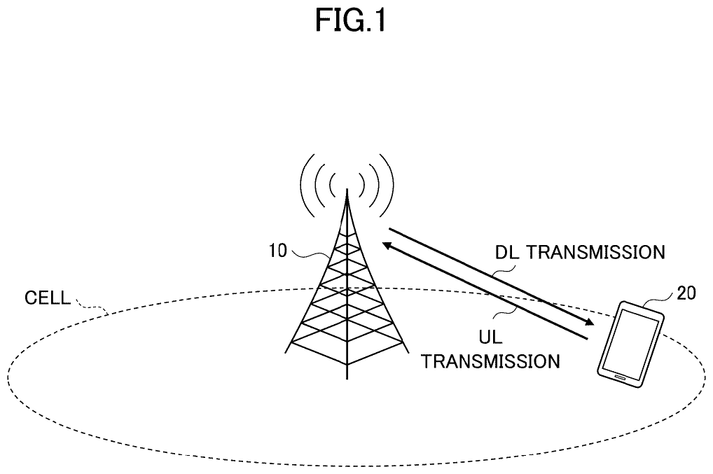

FIG. 1 is a drawing for describing a wireless communication system related to an embodiment of the present invention. As illustrated in FIG. 1, the wireless communication system according to an embodiment of the present invention includes a base station 10 and a terminal 20. In FIG. 1, a single base station 10 and a single terminal 20 are illustrated as an example, but there may be a plurality of base stations 10 and a plurality of terminals 20.

The base station 10 is a communication device that provides one or more cells and performs wireless communication with the terminal 20. Physical resources of radio signals may be defined in the time domain and the frequency domain, the time domain may be defined by the number of OFDM (Orthogonal Frequency Division Multiplexing) symbols, and the frequency domain may be defined by the number of sub-carriers or resource blocks. Further, a TTI (Transmission Time Interval) in the time domain may be a slot, or the TTI may be a subframe.

The base station 10 transmits a synchronization signal and system information to the terminal 20. The synchronization signal is, for example, an NR-PSS and an NR-SSS. The system information is transmitted via, for example, an NR-PBCH, and may be referred to as broadcast information. The synchronization signal and the system information may be referred to as an SSB (SS/PBCH block). As shown in FIG. 1, the base station 10 transmits a control signal or data in DL (Downlink) to the terminal 20 and receives a control signal or data in UL (Uplink) from the terminal 20. The base station 10 and terminal 20 are capable of transmitting and receiving a signal by performing the beamforming. Further, the base station 10 and the terminal 20 can both apply MIMO (Multiple Input Multiple Output) communication to DL or UL. Further, the base station 10 and the terminal 20 may both perform communications via a secondary cell (SCell: Secondary Cell) and a primary cell (PCell: Primary Cell) using CA (Carrier Aggregation). In addition, the terminal 20 may perform communications via a primary cell of the base station 10 and a primary secondary cell group cell (PSCell: Primary SCG Cell) of another base station 10 using DC (Dual Connectivity).

The terminal 20 may be a communication apparatus that includes a wireless communication function such as a smartphone, a mobile phone, a tablet, a wearable terminal, a communication module for M2M (Machine-to-Machine), or the like. As shown in FIG. 1, the terminal 20 uses various communication services provided by the wireless communication system by receiving control signals or data in DL from the base station 10 and transmitting control signals or data in UL to the base station 10. In addition, the terminal 20 receives various reference signals transmitted from the base station 10 and performs measurement of the propagation path quality based on the reception result of the reference signals. Note that the terminal 20 may be referred to as UE, and the base station 10 may be referred to as a gNB.

In addition, in LTE or NR, a carrier aggregation function using a broad band is supported in order to secure data resources. In the carrier aggregation function, wide band data resources can be allocated by bundling a plurality of component carriers. For example, the bandwidth of 100 MHz can be used by bundling a plurality of bandwidths of 20 MHz.

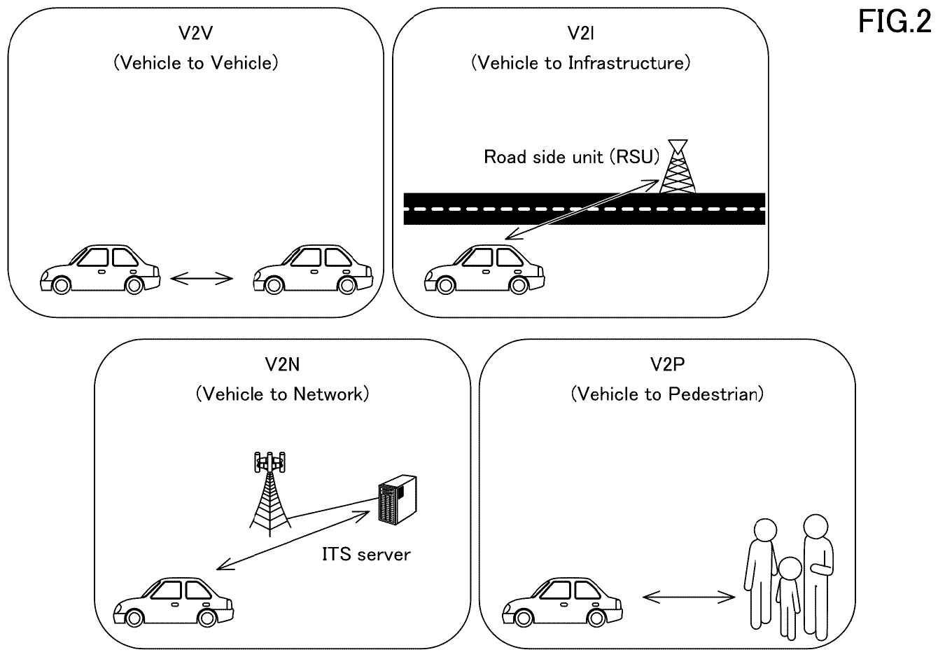

FIG. 2 is a drawing illustrating V2X. In 3GPP, enhancing D2D functions to realize V2X (Vehicle to Everything) or eV2X (enhanced V2x) has been discussed and technical specifications are being developed. As illustrated in FIG. 1, V2X is a part of ITS (Intelligent Transport Systems) and is a generic name (collective name) for: V2V (Vehicle to Vehicle) referring to a form of communication performed between vehicles; V2I (Vehicle to Infrastructure) referring to a form of communication performed between a vehicle and a road-side unit (RSU) that is installed on the roadside; V2N (Vehicle to Network) referring to a form of communication performed between a vehicle and an ITS server; and V2P (Vehicle to Pedestrian) referring to a form of communication performed between a vehicle and a mobile terminal that is carried by a pedestrian.

Further, in 3GPP, V2X using LTE/NR's cellular communication and communication between terminals has been discussed. V2X using cellular communication may be referred to as cellular V2X. In NR V2X, there have been discussions to realize higher system capacity, reduced latency, higher reliability, and QoS (Quality of Service) control.

With respect to LTE V2X or NR V2X, it is anticipated that discussions will go beyond 3GPP specifications in the future. For example, the following items are expected to be discussed: how to secure interoperability; how to reduce cost by implementing higher layers; how to use or how to switch between multiple RATs (Radio Access Technologies); how to handle regulations of each country; how to obtain and distribute data of LTE V2X or NR V2X platform; and how to manage and use databases.

In an embodiment of the present invention, a form of embodiment is mainly assumed in which communication apparatuses are mounted on vehicles. However, an embodiment of the present invention is not limited to such a form. For example, communication apparatuses may be terminals carried by people, may be apparatuses mounted on drones or aircraft, or may be base stations, RSUs, relay stations (relay nodes), terminals capable of scheduling, etc.

It should be noted that SL (Sidelink) may be distinguished from UL (Uplink) or DL (Downlink) based on any one of, or any combination of the following 1) through 4). Furthermore, SL may be referred to as a different name.
1) Resource arrangement in the time domain
2) Resource arrangement in the frequency domain
3) Synchronization signal to be referred to (including SLSS (Sidelink Synchronization Signal))
4) Reference signal that is used for path loss measurement used for transmission power control

Further, with respect to OFDM (Orthogonal Frequency Division Multiplexing) of SL or UL, any of CP-OFDM (Cyclic-Prefix OFDM), DFT-S-OFDM (Discrete Fourier Transform-Spread-OFDM), OFDM without Transform precoding, and OFDM with Transform precoding may be applied.

In LTE SL, with respect to allocating SL resources to a terminal 20, Mode 3 and Mode 4 are defined. In Mode 3, transmission resources are dynamically allocated using a DCI (Downlink Control Information) that is transmitted from a base station 10 to the terminal 20. In addition, SPS (Semi Persistent Scheduling) is available in Mode 3. In Mode 4, the terminal 20 autonomously selects transmission resources from a resource pool.

It should be noted that a slot in an embodiment of the present invention may be read as (replaced with) a symbol, a mini slot, a subframe, a radio frame, a TTI (Transmission Time Interval), or a time resource with a predetermined width. Further, a cell in an embodiment of the present invention may be read as (replaced with) a cell group, a carrier component, a BWP (bandwidth part), a resource pool, a resource, a RAT (Radio Access Technology), a system (including a wireless LAN), etc.

Note that, in an embodiment of the present invention, the terminal 20 is not limited to a V2X terminal, and may be any type of terminal that performs D2D communication. For example, the terminal 20 may be a terminal carried by a user, such as a smartphone, or an IoT (Internet of Things) device, such as a smart meter.

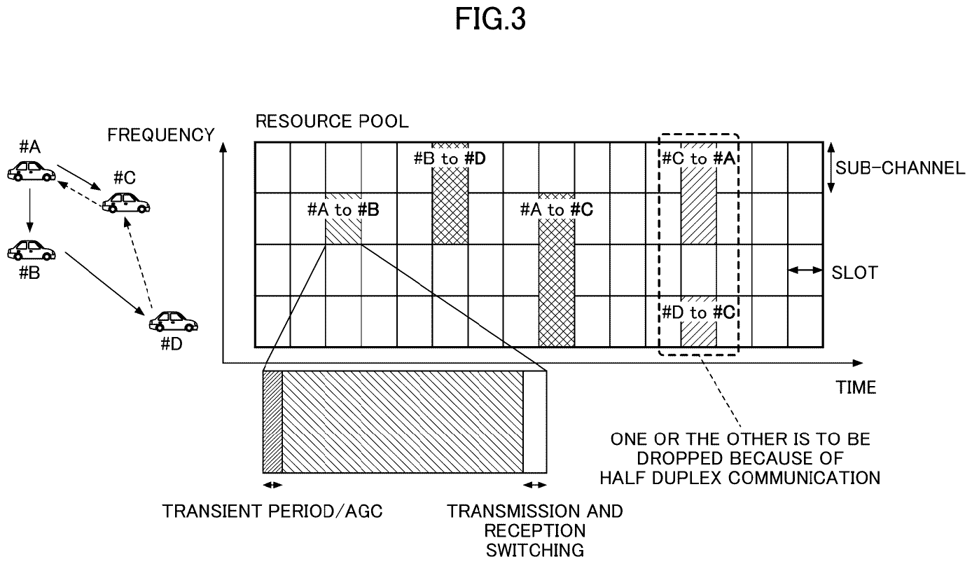

FIG. 3 is a drawing for describing an example of communication in D2D. As illustrated in FIG. 3, it is assumed that there is an environment in which a plurality of pieces of UE, such as UE #A, UE #B, UE #C, and UE #D, perform communications with each other. A resource pool used for transmission and reception by each UE is a set of resources in the time domain and the frequency domain. A resource pool may be configured or pre-configured by the system or the service provider. For example, in a resource pool, a several number of time resources based on a period may be available for the periodic traffic. In addition, for example, in a resource pool, in order to reduce interference onto the Uu interface (radio interface between UTRAN (Universal Terrestrial Radio Access Network) and UE (User Equipment)), several frequency resources may be unavailable.

The sub-channel in a resource pool illustrated in FIG. 3 is a scheduling unit in the frequency domain. For example, {10, 12, 15, 20, 25, 50, 75, 100} PRBs may be configured or pre-configured as one sub-channel.

The slot in a resource pool illustrated in FIG. 3 is a scheduling unit in the time domain. The scheduling in symbol units may be too complicated for a case in which a UE autonomously selects a resource. With respect to the above, the scheduling is not required to be scheduling in slot units.

As illustrated in FIG. 3, the beginning of a slot used for transmission from UE #A to UE #B is a transient period from the perspective of the transmitting UE. The transient period is a period required for transmission power adjustment. On the other hand, from the perspective of the receiving UE, the beginning of a slot used for transmission from UE #A to UE #B is used for AGC (Auto gain control). The reception power greatly varies among links, and thus, a predetermined period is required for adjusting the power range. The increased AGC occasions can be avoided by scheduling in slot units.

As illustrated in FIG. 3, the end of a slot used for transmission from UE #A to UE #B is used for the transmission and reception switching period. After a certain UE performs transmission in slot n, there is a possibility that the certain UE performs reception in slot n+1. The transmission and reception switching period is defined for each slot.

As illustrated in FIG. 3, in a case where a transmission from UE #C to UE #A overlaps with a transmission from UE #D to UE #C in the same slot, one of the transmissions is required to be dropped because UE #C cannot perform a transmission and a reception simultaneously. In other words, the D2D communication is half duplex communication.

It is to be noted that the default configuration in case of out-of-coverage of the base station may be pre-configured. It is to be noted that the RRC connection/configuration between pieces of UE performing unicast is referred to as PC5-RRC connection/configuration.

Here, the positioning is being discussed in the scenarios of the device-to-device direct communications, such as in-coverage, partial-coverage, out-of-coverage, V2X (Vehicle to Everything), public safety, commercial, IIOT (Industrial Internet of Things), or the like. “In-coverage” may mean that a plurality of pieces of UE related to positioning are located in the BS coverage, “partial-coverage” may mean that some of the plurality of pieces of UE related to positioning are located in the BS coverage, and “out-of-coverage” may mean that the plurality of pieces of UE related to positioning are not located in the BS coverage.

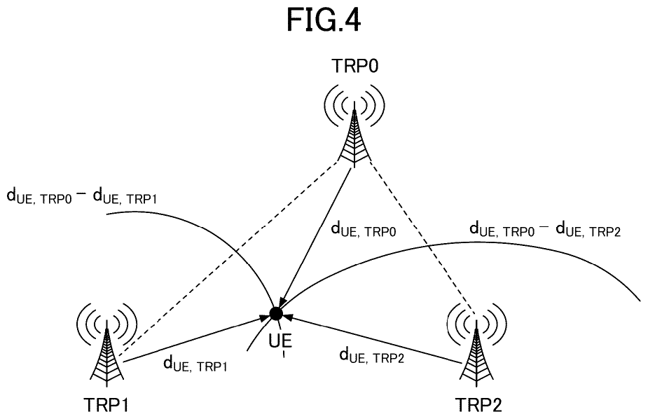

The positioning of the terminal 20 based on the LMF (Location Management Function) in the 3GPP release 16 or 17 Uu interface is performed according to the methods of 1) to 3) described below (refer to non-patent document 3, non patent document 4, and non-patent document 5).
1) Method based on DL-TDOA (Time Difference of Arrival)
2) Method based on UL-TDOA
3) Method based on multi-RTT (Round Trip Time).
FIG. 4 is a drawing illustrating an example (1) of positioning. As illustrated in FIG. 4, the location information of the UE may be calculated based on DL-TDOA. The location of the UE may be estimated based on DL-RSTD (Received Signal Time Difference) in which the UE measures DL wireless signals transmitted from a plurality of NR TRPs. The geographical locations of the TRPs and the DL transmission timings at the TRPs may be used in the estimation. Furthermore, the location of the UE may be estimated based on RSRP (Reference Signal Received Power) of DL-PRS (Positioning Reference Signal) in addition to DL-RSTD.

In a method based on DL-TDOA, the location of the UE may be calculated by the following procedure.
1) The gNB transmits DL-PRS from each TRP to the UE
2) The UE reports DL-RSTD that is a measurement result to the GW and/or gNB and/or LMF by using the LPP (LTE Positioning Protocol)
3) The gNB reports the timing information related to the TRP to the LMF by using the NRPPa (NR Positioning Protocol A)
4) The LMF calculates the location of the UE based on the above-described information reported by the UE and the gNB

For example, as illustrated in FIG. 4, the location of the UE may be calculated based on the geographical location and the DL transmission timing of each of the TRPs by measuring the delay between the UE and the TRP0, the delay between the UE and the TRP1, and the delay between the UE and the TRP2.

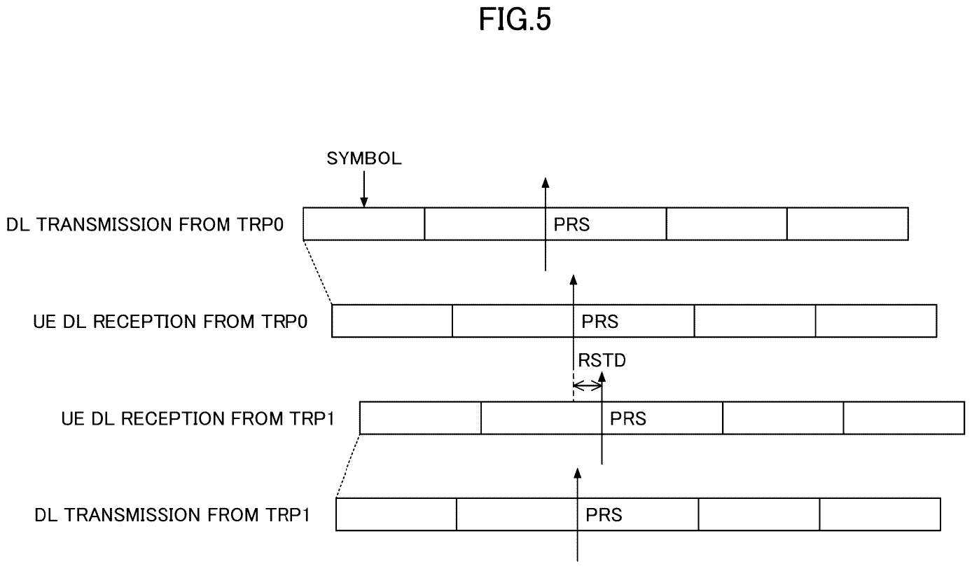

FIG. 5 is a drawing illustrating an example of measuring DL-RSTD. Hereinafter, “and/or” will be also described as “/”. As illustrated in FIG. 5, the DL RSTD may refer to the time difference, measured by the UE, between the time point of the start of reception of a DL subframe from a reference TRP (TRPO in FIG. 5) and the time point of the start of reception of a DL subframe from another TRP. The start of a subframe may be determined by detecting the DL-PRS.

The transmission timing of each trp is not required to be the same.

Regarding the calculation of the location of the UE according to DL-TDOA, information described in 1) to 5) below may be reported from the UE to the GW/gNB/LMF.
1) PCI (Physical Cell ID), GCI (Global Cell ID), and TRP-ID in each measurement
2) DL-RSTD measurement result
3) DL-PRS-RSRP measurement result
4) Measurement time (time stamp)
5) Quality of each measurement Regarding the calculation of the location of the UE according to DL-TDOA, information described in 1) to 6) below may be reported from the gNB to the LMF.
1) PCI, GCI, and TRP-ID of TRPs controlled by the gNB
2) Timing information of TRPs controlled by the gNB
3) DL-PRS configuration of TRPs controlled by the gNB
4) SSB-related information, such as SSB time and frequency resources, of TRPs controlled by the gNB
5) Spatial direction information of the DL-PRS of TRPs controlled by the gNB
6) Geographical coordinates information of TRPs controlled by the gNB

DL-RSTD may be defined as the time difference, measured by the UE, between the time point of the start of reception of a DL subframe from a reference TRP and the time point of the start of reception of a DL subframe from another TRP. A plurality of DL-PRS resources may be used for determining the time point of the start of reception of a subframe.

The SFN initialization time of the TRPs may be reported as a report of the timing information related to the TRPs controlled by the gNB. The SFN initialization time is the beginning time of SFNO.

The ellipsoid point with altitude and the ellipsoid with uncertainty range may be reported as a report of the geographical coordinates information of TRPs controlled by the gNB (refer to non-patent document 6). For example, the latitude, longitude, altitude, direction of altitude, uncertainty range of altitude, or the like, may be reported.

As illustrated in FIG. 4, the location information of the UE may be calculated based on UL-TDOA. The location of the UE may be estimated based on the UL-RTOA (Relative Time of Arrival) in which the UL wireless signal transmitted from the UE is measured by a plurality of NR TRPs. Other configuration information items may be used for the estimation. Furthermore, the location of the UE may be estimated based on RSRP of UL-SRS (Sounding Reference Signal) in addition to the UL-RTOA.

In a method based on UL-TDOA, the location of the UE may be calculated by the following procedure.
1) The UE transmits SRS to a plurality of TRPs
2) The gNB reports UL-RTOA that is a measurement result and the geographical coordinates of the TRPs to the LMF by using NRPPa
3) The LMF calculates the location of the UE based on the above-described information reported by the gNB For example, as illustrated in FIG. 4, the location of the UE may be calculated based on the geographical location and the UL transmission timing of each of the TRPs by measuring the RTOA from the UE to the TRP0, the RTOA from the UE to the TRP1, and the RTOA from the UE to the TRP2.

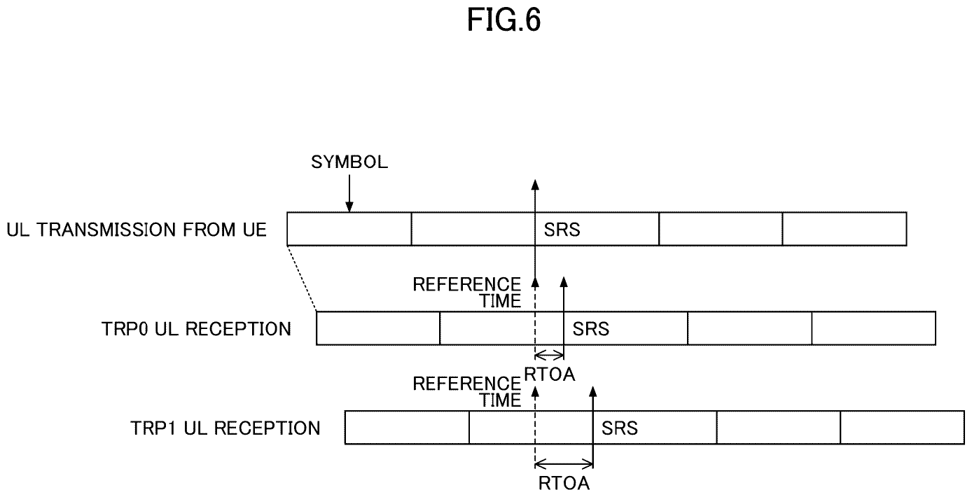

FIG. 6 is a drawing illustrating an example of measuring UL-RTOA.

As illustrated in FIG. 6, the UL-RTOA may refer to the time difference between the time point of the start of reception of a UL subframe including SRS at the TRP and the RTOA reference time at which the UL is transmitted.

Regarding the calculation of the location of the UE according to UL-TDOA, information described in 1) to 9) below may be reported from the gNB to the LMF.
1) PCI, GCI, and TRP-ID of TRPs controlled by the gNB
2) SSB-related information, such as SSB time and frequency resources, of TRPs controlled by the gNB
3) Geographical coordinate information of TRPs controlled by the gNB
4) NCGI (NR Cell Global Identifier) and TRP-ID of the measurement
5) UL-RTOA
6) RSRP of UL-SRS
7) Time of the measurement
8) Quality of each measurement
9) Beam information of each measurement

The UL-RTOA may be defined as the time difference between the time point of the start of reception of a UL subframe including SRS at the TRP and the RTOA reference time at which the UL is transmitted. The gNB may report the geographical coordinates of the TRP to the LMF by using NRPPa.

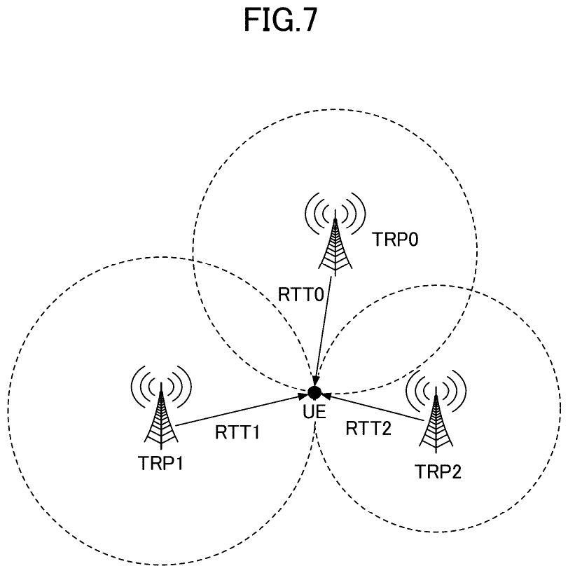

FIG. 7 is a drawing illustrating an example (2) of positioning. As illustrated in FIG. 7, the location information of the UE may be calculated based on a plurality of RTTs. The location of the UE may be estimated based on the UE/gNB reception transmission time difference measurement using DL-PRS and UL-SRS. DL-PRS-RSRP and UL-SRS-RSRP may be used for the estimation. The LMF may determine the RTTs by using the UE/gNB reception-transmission time difference measurement.

In a method based on multi-RTT, the location of the UE may be calculated by the following procedure.
1) The gNB transmits DL-PRS from each TRP to the UE
2) The UE transmits SRS to a plurality of TRPs
3) The UE reports the UE reception transmission time difference to the GW and/or gNB and/or LMF by using the LPP.
4) The gNB reports the gNB reception-transmission time difference to the LMF by using the NRPPa.
5) The LMF calculates the location of the UE based on the above-described information reported by the UE and the gNB

For example, as illustrated in FIG. 7, the location of the UE may be calculated based on the geographical location of each of the TRPs by measuring the RTT between the UE and the TRP0, the RTT between the UE and the TRP1, and the RTT between the UE and the TRP2.

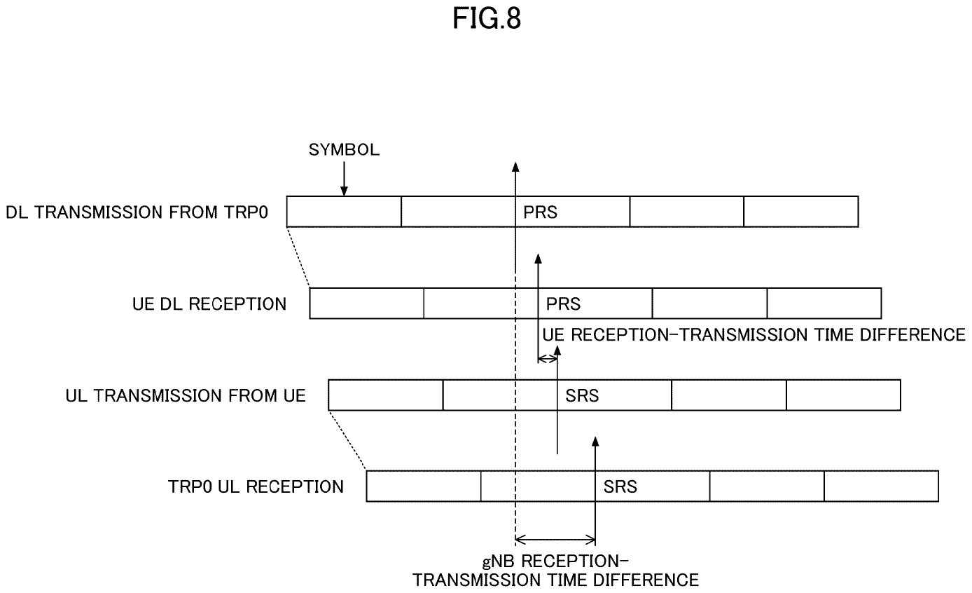

FIG. 8 is a drawing illustrating an example of measuring RTT. As illustrated in FIG. 8, with respect to the UE reception-transmission time difference, the time difference between the timing of receiving a DL subframe from the TRP and the timing of transmitting a UL subframe may be referred to. In addition, as illustrated in FIG. 8, with respect to the gNB reception-transmission time difference, the time difference between the timing of receiving a UL subframe by the TRP and the timing of transmitting a DL subframe by the TRP may be referred to.

Regarding the calculation of the location of the UE according to a plurality of RTTs, information described in 1) to 5) below may be reported from the UE to the GW/gNB/LMF.
1) PCI, GCI, and TRP-ID in each measurement
2) DL-PRS-RSRP measurement result
3) UE reception-transmission time difference measurement result
4) Time of the measurement
5) Quality of each measurement

Regarding the calculation of the location of the UE according to RTTs, information described in 1) to 9) below may be reported from the gNB to the LMF.
1) PCI, GCI, and TRP-ID of TRPs controlled by the gNB
2) Timing information of TRPs controlled by the gNB
3) DL-PRS configuration of TRPs controlled by the gNB
4) SSB-related information, such as SSB time and frequency resources, of TRPs controlled by the gNB
5) Spatial direction information of the DL-PRS of TRPs controlled by the gNB
6) Geographical coordinate information of TRPs controlled by the gNB
7) NCGI and TRP-ID of the measurement
8) gNB reception-transmission time difference
9) RSRP of UL-SRS
10) UL-AoA (Angle of Arrival), for example, azimuth and elevation
11) Time of the measurement
12) Quality of the measurement
13) Beam information of the measurement

It is to be noted that the definitions of the UE reception-transmission time difference and the gNB reception-transmission time difference may be referenced in Non-Patent Document 7. The geographical coordinates of the TRP may be reported in the same way as the DL-RSTD.

As described above, in the positioning according to the Uu interface, the positioning methods have been applied according to the DL-TDOA, the UL-TDOA, and the multi-RTT that respectively use the RSTD, the RTOA, and the reception-transmission time difference that indicate the propagation delay between the UE and the TRP.

Here, in order to perform position estimation by using the sidelink signals, discussions are required with respect to: the position estimation algorithm for the absolute position estimation or relative position estimation; definitions of the sidelink signals for measurement used for the position estimation; and the transmission and reception procedure, the measurement result reporting procedure, or the like. However, the position estimation algorithm for the absolute position estimation or relative position estimation using signals of the device-to-device direct communication has been unclear.

Accordingly, the following operations from option 1) to option 7) may be performed.

Option 1) With respect to the position estimation using the sidelink, a terminal 20 that wants to obtain position information of the terminal 20 itself (hereinafter, referred to as “UE-X”) may transmit a predetermined signal to another terminal 20 (hereinafter, referred to as “UE-Y”) and may receive a signal based on the predetermined signal (for example, measurement results) from UE-Y.

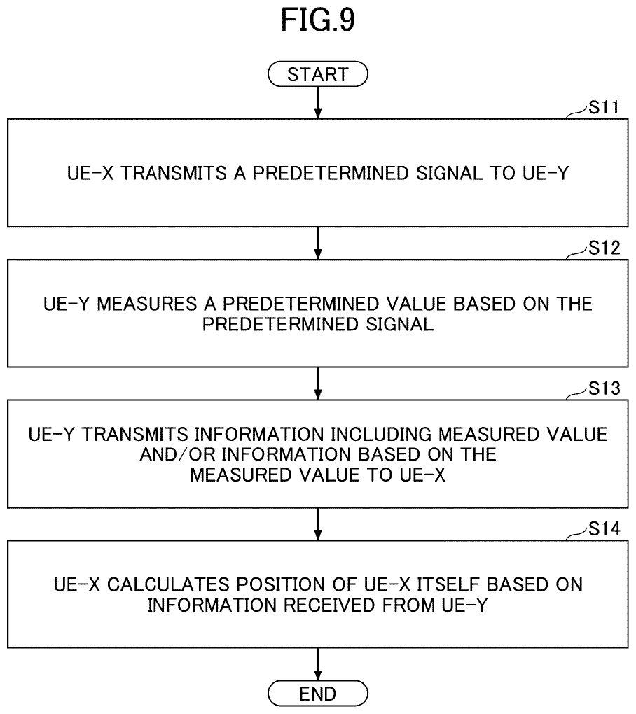

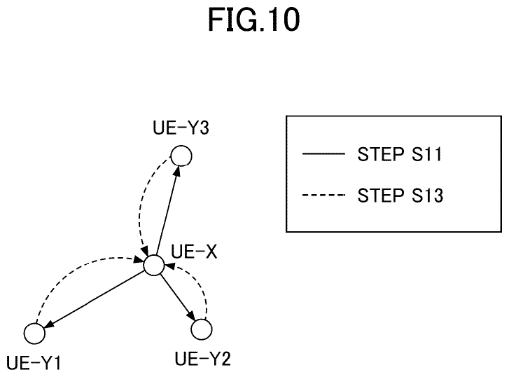

FIG. 9 is a flowchart for describing an example (1) of position estimation related to an embodiment of the present invention. FIG. 10 is a drawing for describing an example (1) of position estimation related to an embodiment of the present invention.

As illustrated in FIG. 9 and FIG. 10, in step S11, UE-X transmits a predetermined signal to UE-Y. In subsequent step S12, UE-Y measures a predetermined value based on the predetermined signal. It is to be noted that step S12 is not required to be applied. In subsequent step S13, UE-Y transmits a signal based on the predetermined signal (for example, may include information including the measured value and/or information based on the measured value) to UE-X. In subsequent step S14, UE-X calculates a position of UE-X itself based on the information received from UE-Y.

For example, UE-Y may be one or more pieces of UE such as UE-Y1, UE-Y2, and UE-Y3 as illustrated in FIG. 10. In other words, UE-X may perform step S11 to step S14 with respect to one or more pieces of UE.

For example, the predetermined signal may be SL-PRS (SL Positioning RS), or may be any one of other SL signals. In addition, the signal transmitted by UE-Y may be SL-PRS, or may be any one of other SL signals.

Hereinafter, the signal used for position estimation is referred to as SL-PRS. However, the signal used for position estimation is not limited to SL-PRS and may be referred to as a different name. It is to be noted that the location estimation and the location measurement may be interchangeably used.

For example, SL-PRS may be multiplexed with PSCCH and/or PSSCH transmission to be transmitted. Alternatively, the SL-PRS may be transmitted by using an SL-PRS dedicated resource. Hereinafter, “PSCCH and/or PSSCH” will be also described as “PSCCH/PSSCH”.

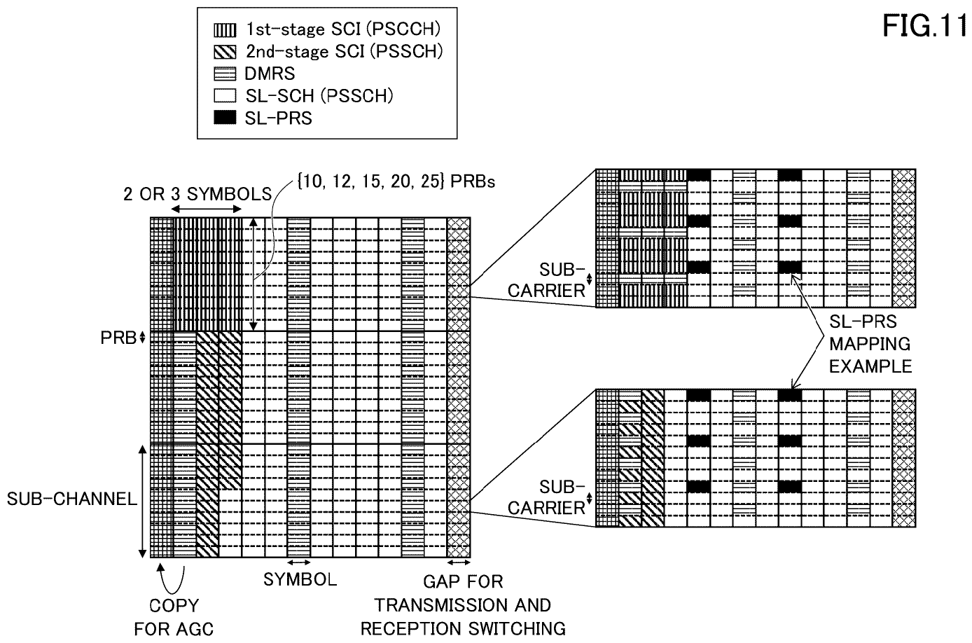

FIG. 11 is a drawing illustrating an example of the arrangement of the reference signal in an embodiment of the present invention. SL-PRS may be arranged as described in the following 1) to 3).
1) SL-PRS is not required to be multiplexed in an RE in which the 2nd-stage SCI and/or DM-RS and/or PT-RS and/or CSI-RS are/is arranged. For example, SL-PRS may be assumed not to overlap with the 2nd-state SCI, DM-RS, PT-RS, and CSI-RS. For example, in a case where the mapping destination of SL-PRS is an RE in which the 2nd-stage SCI, DM-RS, PT-RS, or CSI-RS is arranged, the mapping of SL-PRS to the RE is not required to be performed.
2) SL-PRS is not required to be multiplexed in an RE of PSCCH. For example, SL-PRS may be assumed not to overlap with PSCCH. For example, in a case where the mapping destination of SL-PRS is an RE in which PSCCH is arranged, the PSCCH may be prioritized and the mapping of SL-PRS to the RE is not required to be performed.
3) SL-PRS may be frequency division multiplexed with the 2nd-stage SCI and/or DM-RS and/or PT-RS and/or CSI-RS into the same symbol, or is not required to be frequency division multiplexed into the same symbol.

According to the above-described 1) or the above-described 2), an important signal can be avoided from being replaced with SL-PRS. In addition, according to the above-described 3), the mapping flexibility is improved in a case where SL-PRS is frequency division multiplexed, and the UE operation can be simplified in a case where SL-PRS is not frequency division multiplexed. FIG. 11 is an example of the SL-PRS mapping, and the SL-PRS mapping is not limited to the mapping illustrated in FIG. 11.

For example, in step S14, the position of UE-X itself calculated by UE-X may be an absolute position, or may be a relative position.

For example, Option 1) may be applied to a case of an environment in which UE-X and UE-Y are out-of-coverage (OoC), may be applied to a case of an environment in which UE-X and UE-Y are partial-coverage (PC), or may be applied to a case of an environment in which UE-X and UE-Y are in-coverage (IC).

According to the above-described Option 1), the terminal 20 can perform an operation for obtaining the position information.

Option 2) With respect to the position estimation using the sidelink, UE-X that wants to obtain position information of UE-X itself may transmit a predetermined signal to UE-Y and/or the base station 10 (hereinafter, referred to as “BS-Y”), and may receive a signal based on the predetermined signal (for example, measurement results) from UE-Y and/or BS-Y.

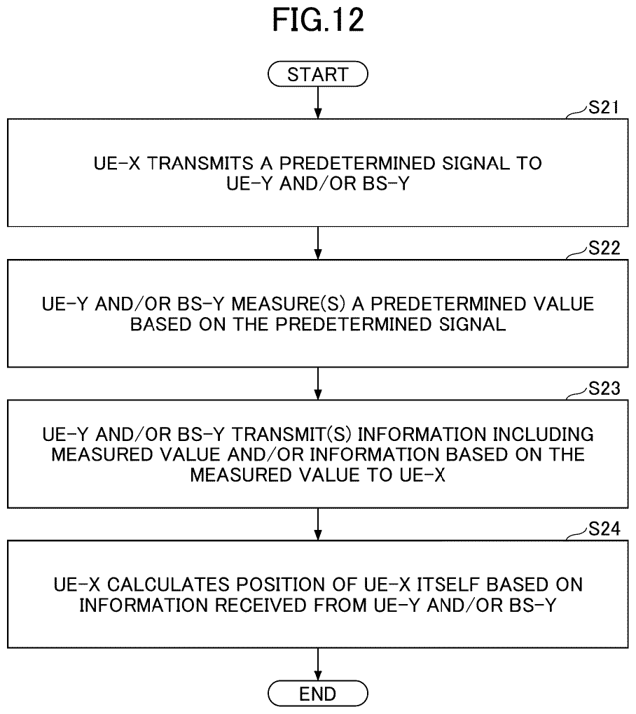

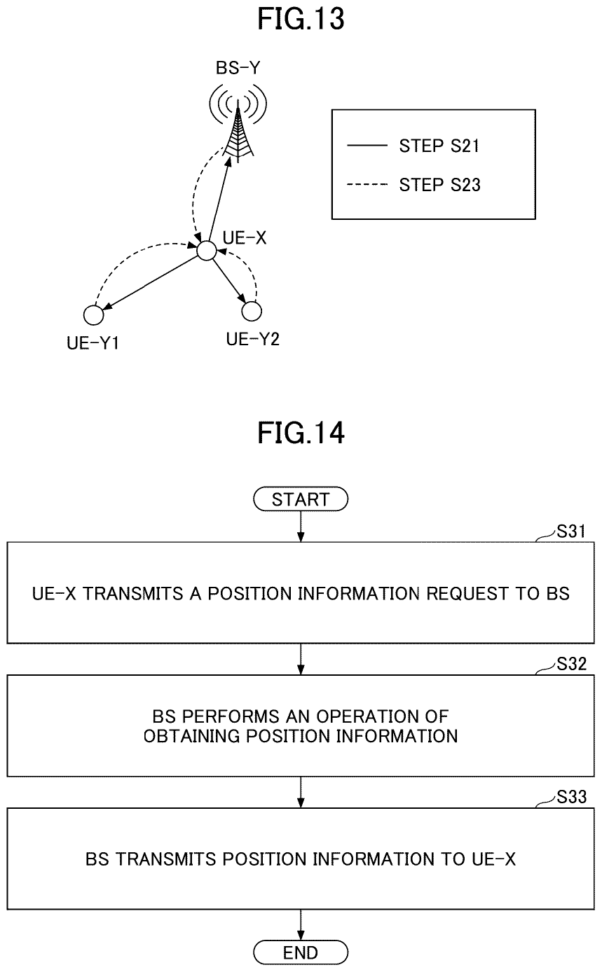

FIG. 12 is a flowchart for describing an example (2) of position estimation related to an embodiment of the present invention. FIG. 13 is a drawing for describing an example (2) of position estimation related to an embodiment of the present invention.

As illustrated in FIG. 12 and FIG. 13, in step S21, UE-X transmits a predetermined signal to UE-Y and/or BS-Y. In subsequent step S22, UE-Y and/or BS-Y measure(s) a predetermined value based on the predetermined signal. It is to be noted that step S22 is not required to be applied. In subsequent step S23, UE-Y and/or BS-Y transmit(s) a signal based on the predetermined signal (for example, may include information including the measured value and/or information based on the measured value) to UE-X. In subsequent step S24, UE-X calculates a position of UE-X itself based on the information received from UE-Y and/or BS-Y.

For example, UE-Y may be one or more pieces of UE such as UE-Y1 and UE-Y2 as illustrated in FIG. 13. In other words, UE-X may perform step S11 to step S14 with respect to one or more pieces of UE. In addition, BS-Y may be one or more BSs.

For example, the predetermined signal directed to UE-Y may be SL-PRS or may be any one of other SL signals. For example, the predetermined signal directed to BS-Y may be SRS or may be any one of other UL signals. In addition, the signal transmitted by UE-Y may be SL-PRS, or may be any one of other SL signals. In addition, the signal transmitted by BS-Y may be DL-PRS, or may be any one of other DL signals.

For example, in step S24, the position of UE-X itself calculated by UE-X may be an absolute position, or may be a relative position.

For example, Option 2) may be applied to a case of a partial-coverage environment or an in-coverage environment. With respect to the above, a case of a partial coverage environment may mean a case in which UE-X is in an in-coverage environment and UE-Y is in an out-of-coverage environment.

According to the above-described Option 2), the terminal 20 can expect to obtain position information with higher accuracy by using the base station 10.

Option 3) UE-X that has obtained a position of UE-X itself may transmit, to BS, a request for transmitting position information. For example, only a terminal 20 that supports a positioning function according to the Uu interface may perform Option 3).

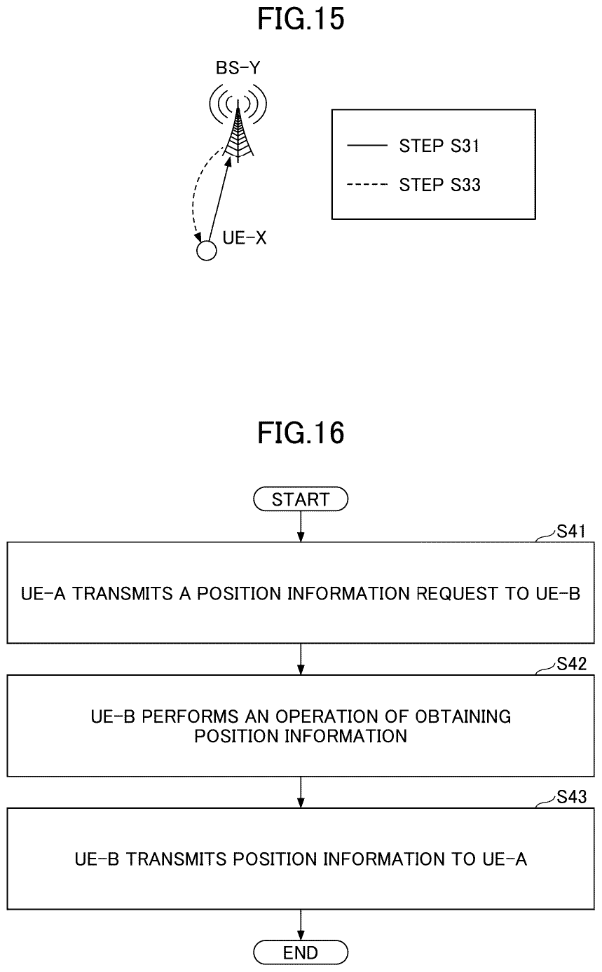

FIG. 14 is a flowchart for describing an example (3) of position estimation related to an embodiment of the present invention. FIG. 15 is a drawing for describing an example (3) of position estimation related to an embodiment of the present invention. As illustrated in FIG. 14 and FIG. 15, in step S31, UE-X transmits a position information request to BS. In subsequent step S32, BS performs an operation of obtaining the position information. In subsequent step S33, BS transmits the position information to UE-X.

For example, in step S32, the above-described positioning function according to the Uu interface may be applied.

For example, step S32 is not required to be performed, or may be skipped. For example, step S32 is not required to be performed in a case where BS has already obtained position information of UE-X. In addition, for example, in a case where BS has already obtained position information of UE-X and the desired accuracy requirement is satisfied, step S32 is not required to be performed. for example, step S33 is not required to be performed, or may be skipped. For example, step S33 is not required to be performed in a case where DL-PRS is transmitted to UE-X from a plurality of BSs/TRPs and positioning is performed by UE-X in step S32.

For example, the position information requested by UE-X may be an absolute position, or may be a relative position.

For example, UE-X may receive, from BS, an indication indicating that the position information is not available, instead of the position information.

After receiving the above-described indication, UE-X may obtain the position information by performing another method, for example, the above-described Option 1) or the above-described Option 2).

According to the above-described Option 3), the terminal 20 can perform an operation for obtaining the position information. The positioning with higher accuracy can be expected to be obtained by using the Uu positioning.

Option 4) Which one of the above-described Option 1), the above-described Option 2), and the above-described Option 3) is to be performed may be determined based on a predetermined condition.

For example, the predetermined condition may be a condition of an out-of-coverage environment, a partial coverage environment, or an in-coverage environment.

For example, the predetermined condition may be a condition of accuracy requirement. In other words, which one of the options is to be applied may be determined based on whether the accuracy requirement is higher or lower than a predetermined threshold value.

For example, the predetermined condition may be a condition of whether an absolute position or a relative position is to be obtained.

For example, the predetermined condition may be a condition of a predetermined priority configured for each option. For example, Option 3) may have the highest priority, Option 2) may have the second highest priority, and Option 3) may have the lowest priority. An operation of performing an option with the next highest priority in a case where an option with the highest priority cannot be performed may be repeatedly performed.

For example, the predetermined condition may be a condition of UE capability. In other words, which option is to be supported may be defined as the UE capability, and the terminal 20 may perform the supported option.

For example, the predetermined condition may be a condition of UE implementation. In other words, the terminal 20 may determine which option is to be performed based on the UE implementation.

According to the above-described Option 4), the terminal 20 can determine which option is to be performed in a case where a plurality of position obtaining methods are available.

Option 5) The terminal 20 (hereinafter, referred to as “UE-A”) that wants to obtain position information of another terminal 20 (hereinafter, referred to as “UE-B”) may transmit, to UE-B, a request for transmitting position information.

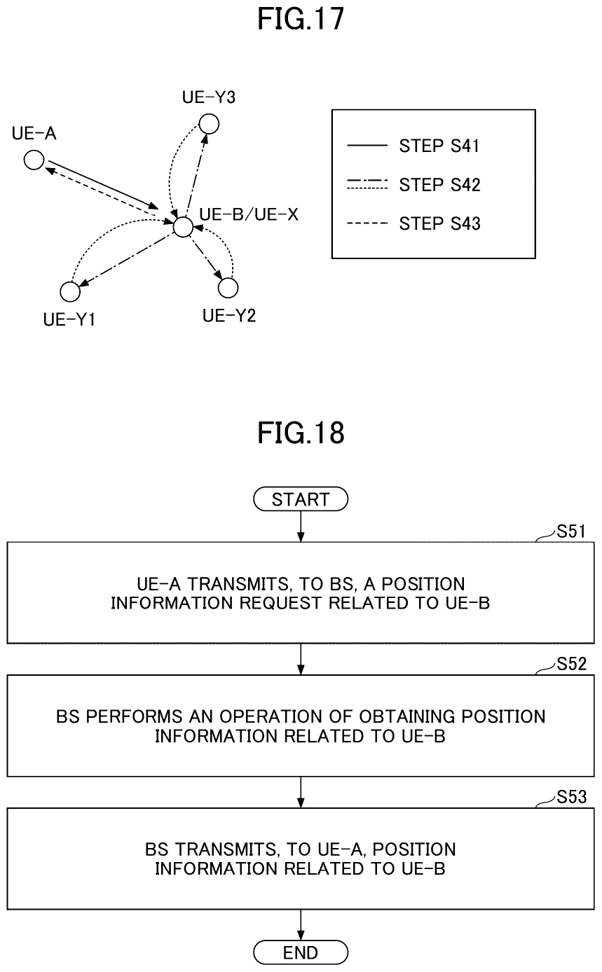

FIG. 16 is a flowchart for describing an example (4) of position estimation related to an embodiment of the present invention. FIG. 17 is a drawing for describing an example (4) of position estimation related to an embodiment of the present invention. As illustrated in FIG. 16 and FIG. 17, in step S41, UE-A transmits, to UE-B, a position information request. In subsequent step S42, UE-B performs an operation of obtaining position information. In subsequent step S43, UE-B transmits the position information of UE-B to UE-A.

For example, in step S42, the above-described Option 1), the above-described Option 2), or the above-described Option 3) may be performed. UE-B may be a UE-X in the above-described Option 1), the above-described Option 2), or the above-described Option 3). UE-A may be or may not be included as a UE-Y in the above-described Option 1), the above-described Option 2), or the above-described Option 3). In a case where UE-A is included as a UE-Y in the above-described Option 1), the above-described Option 2), or the above-described Option 3), one of the steps in the above-described Option 1), the above-described Option 2), or the above-described Option 3) with respect to UE-A is not required to be performed or may be skipped.

For example, step S42 is not required to be performed, or may be skipped. For example, step S42 is not required to be performed in a case where UE-B has already obtained position information of UE-B itself. In addition, for example, in a case where UE-B has already obtained position information of UE-B itself and the desired accuracy requirement is satisfied, step S42 is not required to be performed.

For example, the position information requested by UE-A may be an absolute position, or may be a relative position.

According to the above-described Option 5), a use case and services that require position information of another piece of UE can be supported. In addition, a common operation can be shared between an operation of obtaining the position information of another piece of UE and an operation of obtaining the position information of the UE itself.

Option 6) The terminal 20 (hereinafter, referred to as “UE-A”) that wants to obtain position information of another terminal 20 (hereinafter, referred to as “UE-B”) may transmit, to BS, a request for transmitting position information related to UE-B.

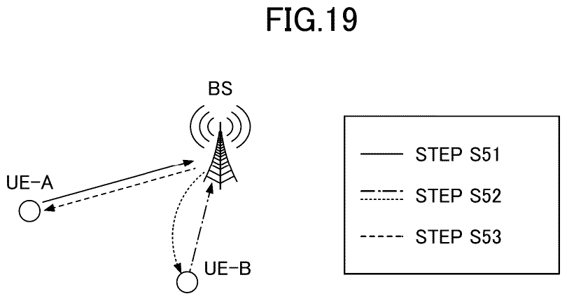

FIG. 18 is a flowchart for describing an example (5) of position estimation related to an embodiment of the present invention. FIG. 19 is a drawing for describing an example (5) of position estimation related to an embodiment of the present invention. As illustrated in FIG. 18 and FIG. 19, in step S51, UE-A transmits, to BS, a request for position information related to UE-B. In subsequent step S52, BS performs an operation of obtaining the position information related to UE-B. In subsequent step S53, BS transmits, to UE-A, the position information related to UE-B.

For example, in step S52, a Uu interface positioning function, for example, the above-described Uu interface positioning function, may be performed.

For example, in step S52, an indication of performing an SL positioning function, for example, the above-described Option 1) or the above-described Option 2, may be transmitted from BS to UE-B. UE-B may perform an SL positioning function, for example, the above-described Option 1) or the above-described Option 2 and may report, to BS, the obtained position information of UE-B itself.

For example, step S52 is not required to be performed, or may be skipped. For example, step S52 is not required to be performed in a case where BS has already obtained position information of UE-B. In addition, for example, in a case where BS has already obtained position information of UE-B and the desired accuracy requirement is satisfied, step S52 is not required to be performed.

For example, the position information requested by UE-A may be an absolute position, or may be a relative position.

For example, UE-A may receive, from BS, an indication indicating that the position information related to UE-B is not available instead of the position information. After receiving the above-described indication, UE-A to may obtain the position information by performing another method, for example, the above-described Option 5).

According to the above-described Option 6), the terminal 20 can perform an operation for obtaining the position information. The positioning with higher accuracy can be expected to be obtained by using the Uu positioning.

Option 7) Which of the above-described Option 5) or the above-described Option 6) is to be performed may be determined based on a predetermined condition.

For example, the predetermined condition may be a condition of an out-of-coverage environment, a partial-coverage environment, or an in-coverage environment.

For example, the predetermined condition may be a condition of accuracy requirement.

For example, the predetermined condition may be a condition of whether an absolute position or a relative position is to be obtained.

For example, the predetermined condition may be a condition of a predetermined priority configured for each option. For example, Option 6) may have a priority that is higher than that of Option 5).

For example, the predetermined condition may be a condition of UE capability. In other words, which option is to be supported may be defined as the UE capability, and the terminal 20 may perform the supported option.

For example, the predetermined condition may be a condition of UE implementation. In other words, the terminal 20 may determine which option is to be performed based on the UE implementation.

According to the above described Option 7), the terminal 20 can determine which option is to be performed in a case where a plurality of position obtaining methods are available.

Here, in the sidelink communication, the time difference, RSRP, and the like, are measured by transmitting and receiving the SL positioning RS (SL-PRS) and are reported to other pieces of UE. The SL-PRS may be transmitted by using a resource pool that is dedicated to SL-PRS. With respect to the above, a channel or a signal other than SL-PRS may be transmitted by using the resource pool that is dedicated to SL-PRS.

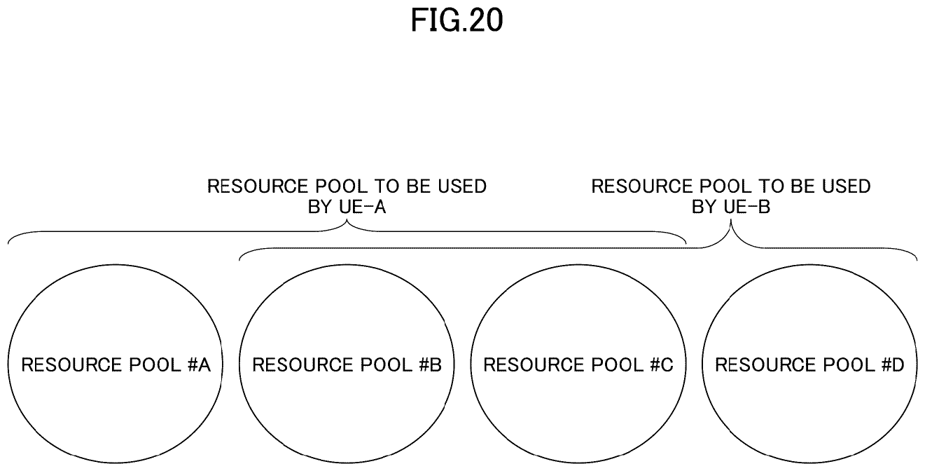

FIG. 20 is a drawing illustrating an example (1) of a resource pool related to an embodiment of the present invention. UE-B receives SL-PRS transmitted by UE-A and reports the measured information to UE-A (measurement report). In a case where the resource pool that is used for transmitting and receiving SL-PRS cannot be used for the measurement report, the measurement report is required to be performed by using other resource pools.

However, as illustrated in FIG. 20, each piece of UE may use different resource pools, and thus, UE-A and UE-B do not necessarily use the common resource pool for SL-PRS and the common resource pool for the measurement report.

Accordingly, in an operation in which UE-A transmits SL-PRS by using a resource pool #0 and UE-B receives the SL-PRS and performs the measurement report by using another resource pool #1, UE-A and/or UE-B may determine the resource pool #0 and the resource pool #1 by using a predetermined method.

Hereinafter, UE-A that transmits SL-PRS by using the resource pool #0 is expected to perform the measurement report (for example, PSSCH) receiving operation by using the resource pool #1. In addition, UE-B that has received the SL-PRS from UE-A is expected to perform transmission by using the resource pool #1 in a case of performing the measurement report.

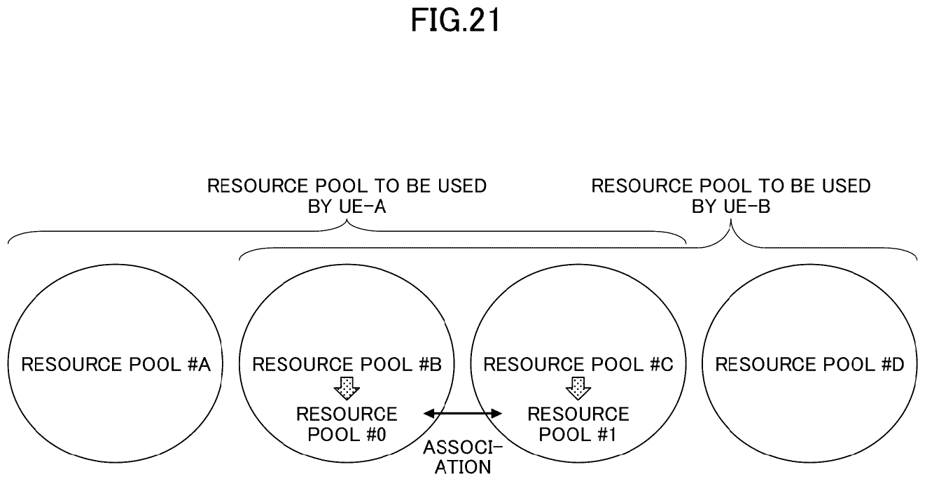

FIG. 21 is a drawing illustrating an example (2) of a resource pool related to an embodiment of the present invention. As illustrated in FIG. 21, the resource pool #0 used for SL-PRS transmission is associated with the corresponding resource pool #1 used for the measurement report in a configuration or a pre-configuration.

In an example illustrated in FIG. 21, a case is illustrated in which UE-A uses a resource pool #A, a resource pool #B, and a resource pool #C, UE-B uses the resource pool #B, the resource pool #C, and a resource pool #D, the resource pool #B is configured as a resource pool #0, and the resource pool #C is configured as a resource pool #1.

According to the association between the resource pool #0 and the resource pool #1, UE-A can transmit SL-PRS by using the resource pool #B, UE-B can receive the SL-PRS by using the resource pool #B, UE-B transmits a measurement report by using the resource pool #C, and UE-A can receive the measurement report by using the resource pool #C.

In order to determine the resource pool #1, one or more candidates of the resource pool may be associated with the resource pool #0 and UE-B may select a resource pool #1 from among the candidates.

In order to determine the resource pool #0, one or more candidates of the resource pool may be associated with the resource pool #1 and UE-A to may select a resource pool #0 from among the candidates.

According to the above-described operation, which resource pool is to be used for performing transmission and reception can be determined without using signaling related to resource pools for each of the SL positioning operations. In other words, the signaling overhead can be reduced.

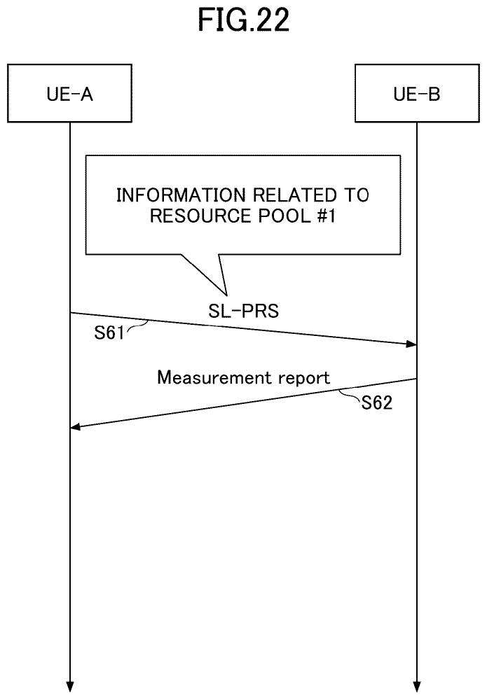

FIG. 22 is a sequence diagram for describing an example (1) of reporting the measurement result in an embodiment of the present invention. As illustrated in FIG. 22, UE-A may indicate, to UE-B, information related to the resource pool #1 used for performing the measurement report at the time when UE-A transmits SL-PRS. The information related to the resource pool #1 may be information indicating a resource pool to be used as the resource pool #1, or may be information indicating a plurality of resource pools to be used as the candidates of the resource pool #1.

In step S61, UE-A transmits, to UE-B, information related to the resource pool #1 at the time when UE-A transmits SL-PRS. In subsequent step S62, UE-B transmits, to UE-A, the measurement report by using a resource pool that is determined based on the received information related to the resource pool #1.

One or more candidates of the resource pool may be associated with the resource pool #0 according to a configuration or pre-configuration, and UE-A may select a resource pool #1 from among the candidates to be indicated to UE-B in step S61.

UE-B that does not use or cannot use the resource pool #1 is not required to perform the measurement report to UE-A.

According to the above-described operation, which resource pool is to be used for performing the measurement report can be determined. In addition, the most appropriate resource pool can be selected based on the utilization state of each resource pool.

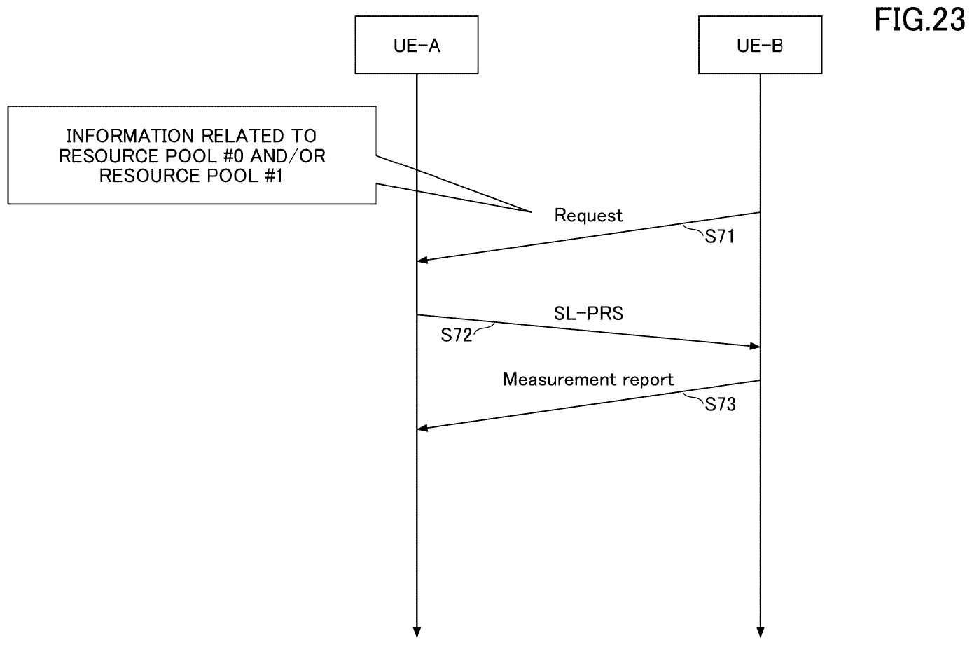

FIG. 23 is a sequence diagram for describing an example (2) of reporting the measurement result in an embodiment of the present invention. As illustrated in FIG. 23, UE-B may transmit an indication related to the resource pool #0 and/or the resource pool #1 at the time when UE-B transmits a request for transmitting SL-PRS. The information related to the resource pool #0 may be information indicating a resource pool to be used as the resource pool #0, or may be information indicating a plurality of resource pools to be used as the candidates of the resource pool #0. The information related to the resource pool #1 may be information indicating a resource pool to be used as the resource pool #1, or may be information indicating a plurality of resource pools to be used as the candidates of the resource pool #1.

In step S71, UE-B transmits, to UE-A, information related to the resource pool #0 and/or the resource pool #1 at the time when UE-B transmits a request for transmitting SL-PRS. In subsequent step S72, in a case where UE-A has received information related to the resource pool #0, UE-A transmits SL-PRS to UE-B by using a resource pool that is determined based on the information related to the resource pool #0. In subsequent step S62, in a case where UE-B has transmitted information related to the resource pool #1, UE-B transmits the measurement report to UE-A by using a resource pool that is determined based on the information related to the resource pool #1.

One or more candidates of the resource pool may be associated with the resource pool #0 according to a configuration or pre-configuration, and UE-B may select a resource pool #1 from among the candidates to be indicated to UE-A in step S71. In addition, one or more candidates of the resource pool may be associated with the resource pool #1 according to a configuration or pre-configuration, and UE-B may select a resource pool #0 from among the candidates to be indicated to UE-A in step S71.

UE-A that does not use or cannot use the resource pool #0 and/or the resource pool #1 is not required to perform the SL-PRS transmission to UE-B.

The request for transmitting SL-PRS may include an indication of the SL-PRS resource.

The resource pool #1 may be a resource pool that is used for performing a request for transmitting SL-PRS.

According to the above-described operation, which resource pool is to be used for performing the SL-PRS transmission and/or the measurement report can be determined. In addition, the most appropriate resource pool can be selected based on the utilization state of each resource pool.

Which resource pool is to be used as the resource pool #0 and/or the resource pool #1 may be configured between UE-A and UE-B by using the PC5-RRC signaling.

One or more candidates of the resource pool may be associated with the resource pool #0 according to the PC5-RRC configuration, and UE-A may select and use a resource pool #1 from among the candidates to be indicated to UE-B, or UE-B may select and use a resource pool #1 from among the candidates to be indicated to UE-A.

One or more candidates of the resource pool may be associated with the resource pool #1 according to the PC5-RRC configuration, and UE-A may select and use a resource pool #0 from among the candidates to be indicated to UE-B, or UE-B may select and use a resource pool #0 from among the candidates to be indicated to UE-A.

One of UE-A and UE-B may transmit, to the other, information related to the resource pool #0 and/or the resource pool #1 (for example, information indicating which resource pool is to be used) and a request for an operation related to the SL positioning, and the other may respond with an indication indicating whether or not an operation corresponding to the request is to be performed. For example, in a case where the UE that has received the request for an operation does not use or cannot use the resource pool #0 and/or the resource pool #1, the UE may respond with a rejection in response to the request for an operation.

One of UE-A and UE-B may transmit, to the other, information related to the resource pool #0 and/or the resource pool #1 (for example, information indicating which resource pool is to be used), and the other may transmit a request for an operation related to the SL positioning and/or an indication related to the resource pool, based on the information.

According to the above-described operation, the negotiation related to the resource pools to be used may be performed between the UEs performing the SL positioning.

When determining counterpart UE that performs an operation related to the SL positioning (for example, SL-PRS transmission and reception, measurement reporting, or the like), UE-A or UE-B may determine the counterpart UE based on which resource pool is to be used or can be used as the resource pool #0 and/or the resource pool #1.

Information indicating which resource pool is to be used or can be used as the resource pool #0 and/or the resource pool #1 may be transmitted to the counterpart UE by using SCI, MAC-CE, or PC5-RRC signaling.

According to the above-described operation, another UE that can appropriately perform an operation of the SL positioning can be selected and the operation can be performed.

In an embodiment of the present invention, UE may be replaced with BS, and an SL signal may be replaced with a UL signal (DL/UL).

The above-described embodiment may be applied to the D2D of NR, or may be applied to the D2D of another RAT. In addition, the above-described embodiment may be applied to FR2, or may be applied to another frequency band.

The above embodiments need not be limited to V2X terminals, and may be applied to terminals performing D2D communication.

Performance of the operation in the above embodiments may be limited to a specific resource pool. For example, the operation in the above embodiments may be performed only in a resource pool that can be used by the terminal 20 of 3GPP release 17 or 3GPP release 18 or later.

According to an embodiment of the present invention, the resource pool used for transmitting and receiving the positioning reference signal in the device-to-device direct communication and the resource pool used for reporting the measurement results can be determined and the positioning operation can be performed.

In other words, the measurement results of the positioning reference signal in the device-to-device direct communication can be reported.

### Device Configuration

Next, a functional configuration example of the base station 10 and the terminal 20 for performing the processes and operations described above will be described. The base station 10 and the terminal 20 include functions for implementing the embodiments described above. It should be noted, however, that each of the base stations 10 and the terminal 20 may include only some of the functions in an embodiment.

### Base Station 10

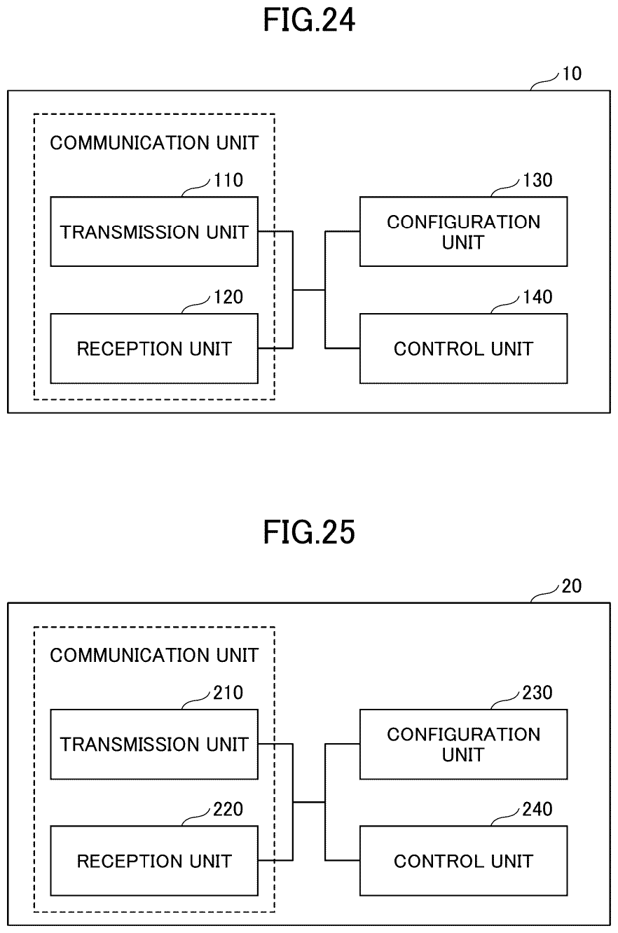

FIG. 24 is a diagram illustrating an example of a functional configuration of the base station 10. As shown in FIG. 24, the base station 10 includes a transmission unit 110, a reception unit 120, a configuration unit 130, and a control unit 140. The functional configuration illustrated in FIG. 24 is merely an example. Functional divisions and names of functional units may be anything as long as operations according to an embodiment of the present invention can be performed.

The transmission unit 110 includes a function for generating a signal to be transmitted to the terminal 20 side and transmitting the signal wirelessly. The reception unit 120 includes a function for receiving various signals transmitted from the terminal 20 and acquiring, for example, information of a higher layer from the received signals. Further, the transmission unit 110 has a function to transmit NR-PSS, NR-SSS, NR-PBCH, DL/UL control signals, DL reference signals, and the like to the terminal 20.

The configuration unit 130 stores preset configuration information and various configuration information items to be transmitted to the terminal 20 in a storage apparatus and reads the preset configuration information from the storage apparatus as necessary. Contents of the configuration information are, for example, information related to configuration of D2D communication, etc.

As described in an embodiment, the control unit 140 performs processing related to the configuration in which the terminal 20 performs D2D communication. Further, the control unit 140 transmits scheduling of D2D communication and DL communication to the terminal 20 through the transmission unit 110. Further, the control unit 140 receives information related to the HARQ response of the D2D communication and the DL communication from the terminal 20 via the reception unit 120. The functional units related to signal transmission in the control unit 140 may be included in the transmission unit 110, and the functional units related to signal reception in the control unit 140 may be included in the reception unit 120.

### Terminal 20

FIG. 25 is a diagram illustrating an example of a functional configuration of the terminal 20. As shown in FIG. 25, the terminal 20 includes a transmission unit 210, a reception unit 220, a configuration unit 230, and a control unit 240. The functional configuration illustrated in FIG. 25 is merely an example. Functional divisions and names of functional units may be anything as long as operations according to an embodiment of the present invention can be performed.

The above-described transmission and reception mechanism (module) of LTE-SL and the above-described transmission and reception mechanism (module) of NR-SL may each include the transmission unit 210, the reception unit 220, the configuration unit 230, and the control unit 240.

The transmission unit 210 generates a transmission signal from transmission data and transmits the transmission signal wirelessly. The reception unit 220 receives various signals wirelessly and obtains higher layer signals from the received physical layer signals. Further, the reception unit 220 has a function for receiving NR-PSS, NR-SSS, NR-PBCH, DL/UL/SL control signals, or reference signals transmitted from the base station 10. Further, for example, with respect to the D2D communications, the transmission unit 210 transmits, to another terminal 20, PSCCH (Physical Sidelink Control Channel), PSSCH (Physical Sidelink Shared Channel), PSDCH (Physical Sidelink Discovery Channel), PSBCH (Physical Sidelink Broadcast Channel), etc., and the reception unit 220 receives, from the another terminal 20, PSCCH, PSSCH, PSDCH, or PSCBCH.

The configuration unit 230 stores various configuration information received from the base station 10 or the terminal 20 by the reception unit 220 in the storage apparatus and reads them from the storage apparatus as necessary. In addition, the configuration unit 230 also stores pre-configured configuration information. Contents of the configuration information are, for example, information related to configuration of D2D communication, etc.

The control unit 240 controls D2D communication for establishing RRC connection with another terminal 20 as described in an embodiment of the present invention. Further, the control unit 240 performs processing related to the power-saving operation. Further, the control unit 240 performs HARQ related processing of the D2D communication and DL communication. Further, the control unit 240 transmits, to the base station 10, information related to the HARQ response of the D2D communication to the other terminal 20 and the DL communication scheduled by the base station 10. Further, the control unit 240 may perform scheduling of D2D communication for another terminal 20. In addition, the control unit 240 may autonomously select a resource to be used for D2D communication from the resource selection window, based on the sensing result, or may perform reevaluation or preemption. Further, the control unit 240 performs processing related to power saving in transmission and reception of D2D communications. In addition, the control unit 240 performs processing related to inter-terminal coordination in D2D communication. The functional units related to signal transmission in the control unit 240 may be included in the transmission unit 210, and the functional units related to signal reception in the control unit 240 may be included in the reception unit 220.

### Hardware Structure

The block diagrams that have been used to describe the above embodiments (FIG. 24 and FIG. 25) show blocks in functional units. These functional blocks (components) may be implemented in arbitrary combinations of at least one of hardware or software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining software into the apparatus described above or the plurality of apparatuses described above.

Functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

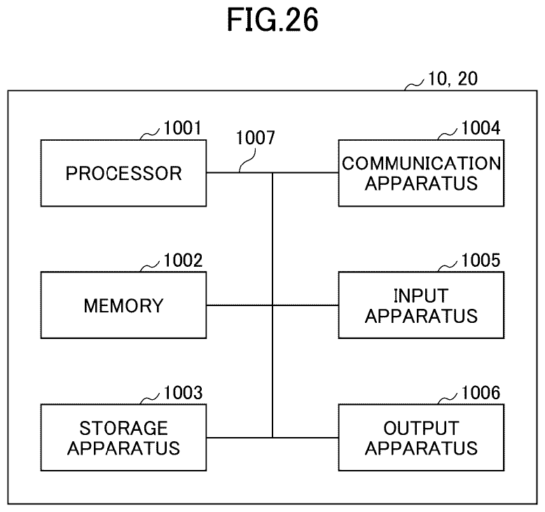

For example, the base station 10, the terminal 20, etc., according to an embodiment of the present disclosure may function as a computer for processing the radio communication method of the present disclosure. FIG. 26 is a diagram to show an example of a hardware structure of the base station 10 and the terminal 20 according to one embodiment. Physically, the above-described base station 10 and terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the terminal 20 may be configured to include one or more of apparatuses shown in the drawings, or may be configured not to include part of apparatuses.

Each function of the base station 10 and the terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading or writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, the above-described control unit 140, control unit 240, and so on may be implemented by the processor 1001.

Furthermore, the processor 1001 reads programs (program codes), software modules, data, or the like, from at least one of the storage 1003 and the communication apparatus 1004, into the memory 1002, and executes various processes according to these. As for the programs, programs to allow computers to execute at least part of the operations of the above-described embodiments are used. For example, the control unit 140 of the base station 10 illustrated in FIG. 24 may be implemented by control programs that are stored in the memory 1002 and that operate on the processor 1001. In addition, for example, the control unit 240 of the terminal 20 illustrated in FIG. 25 may be implemented by control programs that are stored in the memory 1002 and that operate on the processor 1001. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The memory 1002 is a computer-readable recording medium, and may be constituted with, for example, at least one of a Read Only Memory (ROM), an Erasable Programmable ROM (EPROM), an Electrically Erasable Programmable ROM (EEPROM), a Random Access Memory (RAM), or other appropriate storage media. The memory 1002 may be referred to as a “register,” a “cache,” a “main memory (primary storage apparatus)” and so on. The memory 1002 can store executable programs (program codes), software modules, and the like for implementing the communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, or other appropriate storage media. The above recording medium may be a database including the memory 1002 and/or the storage 1003, a server, or any other appropriate medium.

The communication apparatus 1004 is hardware (transmitting/receiving device) for allowing inter-computer communication via at least one of wired or wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) or time division duplex (TDD). For example, the transmitting/receiving antenna, the amplifier unit, the transmitting/receiving unit, the transmission line interface, and the like, may be implemented by the communication apparatus 1004. The transmitting/receiving unit may be implemented by physically or logically being divided into a transmitting unit and a receiving unit.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

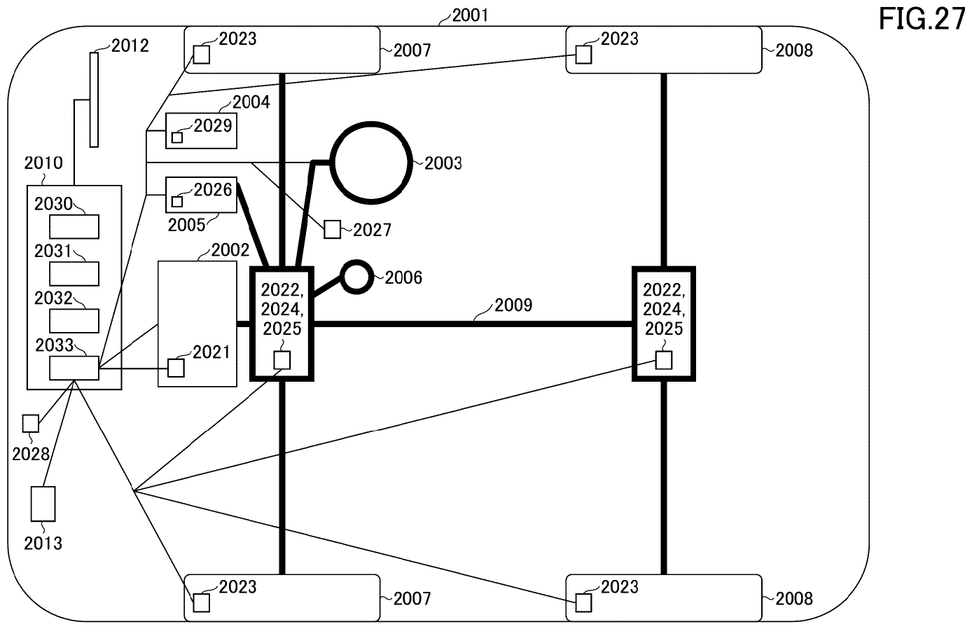

FIG. 27 shows an example of a configuration of a vehicle 2001. As shown in FIG. 27, the vehicle 2001 includes a drive unit 2002, a steering unit 2003, an accelerator pedal 2004, a brake pedal 2005, a shift lever 2006, a front wheel 2007, a rear wheel 2008, an axle 2009, an electronic control unit 2010, various sensors 2021 2029, an information service unit 2012, and a communication module 2013. The aspects/embodiments described in the present disclosure may be applied to a communication device mounted in the vehicle 2001, and may be applied to, for example, the communication module 2013.

The drive unit 2002 may include, for example, an engine, a motor, and a hybrid of an engine and a motor. The steering unit 2003 includes at least a steering wheel and is configured to steer at least one of the front wheel or the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the various sensors 2021-2029 provided in the vehicle 2001. The electronic control unit 2010 may be referred to as an ECU (Electronic control unit).

The signals from the various sensors 2021 to 2029 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, a stepped-on accelerator pedal signal acquired by an accelerator pedal sensor 2029, a stepped-on brake pedal signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing (outputting) various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 2001 by using information obtained from the external device through the communication module 2013 or the like. The information service unit 2012 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving support system unit 2030 includes: various devices for providing functions of preventing accidents and reducing driver's operating loads such as a millimeter wave radar, a LiDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 2001 via a communication port. For example, the communication module 2013 transmits and receives data via a communication port 2033, to and from the drive unit 2002, the steering unit 2003, the accelerator pedal 2004, the brake pedal 2005, the shift lever 2006, the front wheel 2007, the rear wheel 2008, the axle 2009, the microprocessor 2031 and the memory (ROM, RAM) 2032 in the electronic control unit 2010, and sensors 2021 to 2029 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, a base station, a mobile station, or the like.

The communication module 2013 may transmit, to an external device by using wireless communications, at least one of: a signal from the above-described various sensors 2021 to 2028 that is input to the electronic control unit 2010; information that is obtained based on the signal; or information based on an input obtained from outside (user) via the information service unit 2012. The electronic control unit 2010, the various sensors 2021 to 2028, the information service unit 2012, or the like, may be referred to as an input unit for receiving an input. For example, the PUSCH transmitted by the communication module 2013 may include information based on the input.

The communication module 2013 receives various types of information (traffic information, signal information, inter-vehicle information, etc.) transmitted from the external devices and displays the received information on the information service unit 2012 provided in the vehicle 2001. The information service unit 2012 may be referred to as an output unit that outputs information (for example, outputs information to devices, such as a display and a speaker, based on the PDSCH received by the communication module 2013 (or data/information decoded from the PDSCH)). In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the front wheel 2007, the rear wheel 2008, the axle 2009, the sensors 2021-2029, etc., mounted in the vehicle 2001.

### Embodiment Summary

As described above, according to an embodiment of the present invention, a terminal is provided. The terminal includes: a reception unit configured to receive a signal related to positioning in device-to-device direct communication from a terminal in a first resource pool; a control unit configured to perform measurement based on the signal related to positioning in the device-to-device direct communication; and a transmission unit configured to transmit information based on the measurement to the terminal in a second resource pool. The control unit determines the first resource pool and the second resource pool.

According to the above-described configuration, the resource pool used for transmitting and receiving the positioning reference signal in the device-to-device direct communication and the resource pool used for reporting the measurement results can be determined and the positioning operation can be performed. In other words, the measurement results of the positioning reference signal in the device-to-device direct communication can be reported.

The control unit may determine the second resource pool from one or more resource pool candidates associated with the first resource pool. According to the above-described configuration, the resource pool used for transmitting and receiving the positioning reference signal in the device-to-device direct communication and the resource pool used for reporting the measurement results can be determined and the positioning operation can be performed.

The reception unit may receive information related to the second resource pool from the terminal, and the control unit may determine the second resource pool based on the information. According to the above-described configuration, the resource pool used for transmitting and receiving the positioning reference signal in the device-to-device direct communication and the resource pool used for reporting the measurement results can be determined and the positioning operation can be performed.

The control unit may determine the first resource pool from one or more resource pool candidates associated with the second resource pool, and the transmission unit may transmit, to the terminal, a request of transmission of the signal related to positioning in the device-to-device direct communication including information related to the first resource pool. According to the above-described configuration, the resource pool used for transmitting and receiving the positioning reference signal in the device-to-device direct communication and the resource pool used for reporting the measurement results can be determined and the positioning operation can be performed.

In a case where the reception unit receives, from the terminal, information related to the second resource pool and a request of an operation related to positioning and where the second resource pool based on the information cannot be used, the transmission unit may transmit, to the terminal, a rejection to the request of the operation. According to the above-described configuration, the resource pool used for transmitting and receiving the positioning reference signal in the device-to-device direct communication and the resource pool used for reporting the measurement results can be determined and the positioning operation can be performed.

In addition, according to an embodiment of the present invention, a positioning method performed by a terminal is provided. The positioning method includes: receiving a signal related to positioning in device-to-device direct communication from a terminal in a first resource pool; performing measurement based on the signal related to positioning in the device-to-device direct communication; transmitting information based on the measurement to the terminal in a second resource pool; and determining the first resource pool and the second resource pool.

According to the above-described configuration, the resource pool used for transmitting and receiving the positioning reference signal in the device-to-device direct communication and the resource pool used for reporting the measurement results can be determined and the positioning operation can be performed. In other words, the measurement results of the positioning reference signal in the device-to-device direct communication can be reported.

### Supplement of Embodiment

As described above, one or more embodiments have been described. The present invention is not limited to the above embodiments. A person skilled in the art should understand that there are various modifications, variations, alternatives, replacements, etc., of the embodiments. In order to facilitate understanding of the present invention, specific values have been used in the description. However, unless otherwise specified, those values are merely examples and other appropriate values may be used. The division of the described items may not be essential to the present invention. The things that have been described in two or more items may be used in a combination if necessary, and the thing that has been described in one item may be appropriately applied to another item (as long as there is no contradiction). Boundaries of functional units or processing units in the functional block diagrams do not necessarily correspond to the boundaries of physical parts. Operations of multiple functional units may be physically performed by a single part, or an operation of a single functional unit may be physically performed by multiple parts. The order of sequences and flowcharts described in an embodiment of the present invention may be changed as long as there is no contradiction. For the sake of description convenience, the base station 10 and the terminal 20 have been described by using functional block diagrams. However, the apparatuses may be realized by hardware, software, or a combination of hardware and software. The software executed by a processor included in the base station 10 according to an embodiment of the present invention and the software executed by a processor included in the terminal 20 according to an embodiment of the present invention may be stored in a random access memory (RAM), a flash memory, a read only memory (ROM), an EPROM, an EEPROM, a register, a hard disk (HDD), a removable disk, a CD-ROM, a database, a server, or any other appropriate recording medium.

In addition, notification of information is by no means limited to the aspects/embodiments described in the present disclosure, and other methods may be used as well. For example, the information indication may be performed by physical layer signaling (e.g., DCI (Downlink Control Information), UCI (Uplink Control Information)), higher layer signaling (e.g., RRC (Radio Resource Control) signaling, MAC (Medium Access Control) signaling, broadcast information (MIB (Master Information Block), SIB (System Information Block))), other signals, or combinations thereof. Also, RRC signaling may be referred to as an “RRC message,” and can be, for example, an RRC connection setup message, an RRC connection reconfiguration The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra Wide Band (UWB), Bluetooth (registered trademark), systems that use other adequate radio communication methods, next-generation systems that are enhanced, modified, created, or defined based on these, and the like. A plurality of systems may be combined (for example, a combination of LTE or LTE-A and 5G, and the like) for application.

The order of processes, sequences, flowcharts, and so on that have been used to describe the aspects/embodiments in the present specification may be re ordered as long as inconsistencies do not arise. For example, although various methods have been illustrated in the present disclosure with various components of steps in exemplary orders, the specific orders that are illustrated herein are by no means limiting.

Operations which have been described in the present specification to be performed by a base station 10 may, in some cases, be performed by an upper node of the base station 10. In a network including one or a plurality of network nodes with base stations 10, it is clear that various operations that are performed to communicate with terminals 20 can be performed by base stations 10, one or more network nodes (for example, Mobility Management Entities (MMEs), Serving-Gateways (S-GWs), and so on may be possible, but these are not limiting) other than base stations 10, or combinations of these. According to the above, a case is described in which there is a single network node other than the base station 10. However, a combination of multiple other network nodes may be considered (e.g., MME and S-GW).

The information or signals described in this disclosure may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a Software should be broadly interpreted to mean, whether referred to as software, firmware, middle ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) or wireless technologies (infrared, microwave, etc.), at least one of these wired line technologies or wireless technologies is included within the definition of the transmission medium.

Information, a signal, or the like, described in the present specification may be represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and/or a term required for understanding of the present specification may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a “small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))).

The term “cell” or “sector” refers to part of or the entire coverage area of at least one of a base station or a base station subsystem that provides communication services within this coverage.

In the present disclosure, transmitting information to the terminal by the base station may be referred to as instructing the terminal to perform any control and/or operation based on the information by the base station.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station or a mobile station may be referred to as a “transmitting apparatus,” a “receiving apparatus,” a “radio communication apparatus,” and so on. Note that at least one of a base station or a mobile station may be a device mounted on a moving object or a moving object itself, and so on. The mobile station is an object that can move, and the moving speed can be any speed. In addition, a mobile station that is not moving is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving. The moving object may be a vehicle (for example, a car, an airplane, and the like), may be a moving object which moves unmanned (for example, a drone, an automatic operation car, and the like), or may be a robot (a manned type or unmanned type). Note that at least one of a base station or a mobile station also includes an apparatus which does not necessarily move during communication operation. For example, at least one of the base station or the mobile station may be an IoT (Internet of Things) device such as a sensor.

Furthermore, the base station in the present disclosure may be interpreted as a user terminal. For example, each aspect/embodiment of the present disclosure may be applied to the structure that replaces a communication between a base station and a user terminal with a communication between a plurality of terminals 20 (for example, which may be referred to as “Device-to-Device (D2D),” “Vehicle-to-Everything (V2X),” and the like). In this case, terminals 20 may have the functions of the base stations 10 described above. The words such as “uplink” and “downlink” may be interpreted as the words corresponding to the terminal-to-terminal communication (for example, “sidelink”). For example, an uplink channel, a downlink channel and so on may be interpreted as a sidelink channel.

Likewise, the user terminal in the present disclosure may be interpreted as base station. In this case, the base station may have the functions of the user terminal described above.

As used herein, the term “determining” may encompasses a wide variety of actions. For example, “determining” may be regarded as judging, calculating, computing, processing, deriving, investigating, looking up (search, inquiry) (e.g., looking up in a table, a database or another data structure), ascertaining and the like. Also, “determining” may be regarded as receiving (e.g., receiving information), transmitting (e.g., transmitting information), inputting, outputting, accessing (e.g., accessing data in a memory) and the like. Also, “determining” may be regarded as resolving, selecting, choosing, establishing, comparing, and the like. That is, “determining” may be regarded as a certain type of action related to determining. Further, “decision” may be read as “assuming”, “expecting”, or “considering”, etc.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

A reference signal may be abbreviated as an “RS,” and may be referred to as a “pilot,” and so on, depending on which standard applies.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

“Means” included in the configuration of each of the above apparatuses may be replaced by “parts”, “circuits”, “devices”, etc.

In the case where the terms “include”, “including” and variations thereof are used in the present disclosure, these terms are intended to be comprehensive in the same way as the term “comprising”. Further, the term “or” used in the present specification is not intended to be an “exclusive or”.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

The numerology may be a communication parameter applied to at least one of transmission and reception of a certain signal or channel. The numerology may indicate at least one of a subcarrier spacing (SCS), a bandwidth, a symbol length, a cyclic prefix length, a transmission time interval (TTI), the number of symbols per TTI, a radio frame structure, a specific filtering process performed by a transceiver in the frequency domain, a specific windowing process performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). A slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms.

For example, one subframe may be referred to as a transmission time interval, “TTI,” a plurality of consecutive subframes may be referred to as a “TTI,” or one slot or one mini-slot may be referred to as a “TTI.” In other words, at least one of a subframe or a TTI may be a subframe (1 ms) in existing LTE, may be a period shorter than 1 ms (for example, 1 to 13 symbols), or may be a period longer than 1 ms. Note that a unit expressing TTI may be referred to as a “slot,” a “mini-slot,” or the like, instead of a “subframe.”

Here, a TTI refers to the minimum time unit of scheduling in radio communication, for example. For example, in LTE systems, a base station performs, for terminals 20, scheduling of allocating radio resources (such as a frequency bandwidth and transmit power available for each terminal 20) in TTI units. Note that the definition of the TTI is not limited to this.

The TTI may be a transmission time unit for channel-encoded data packets (transport blocks), code blocks, codewords, or the like, or may be a unit of processing in scheduling, link adaptation, or the like. Note that, when a TTI is given, a time interval (for example, the number of symbols) to which transport blocks, code blocks, codewords, or the like are actually mapped may be shorter than the TTI.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in LTE Rel. 8 to Rel. 12), a “long TTI,” a “normal subframe,” a “long subframe,” a “slot,” or the like. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, or the like) may be interpreted as a TTI having a time length exceeding 1 ms, and a short TTI (for example, a shortened TTI or the like) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

An RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG), ”a “PRB pair,” an “RB pair” and so on.

Furthermore, a resource block may be constituted of one or a plurality of resource elements (Res). For example, one RE may correspond to a radio resource field of one subcarrier and one symbol.

A bandwidth part (BWP) (which may be also referred to as a fractional bandwidth, and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for UL) and a DL BWP (BWP for DL). One or a plurality of BWPs may be configured in one carrier for a terminal 20.

At least one of configured BWPs may be active, and a terminal 20 may not need to assume to transmit/receive a certain signal/channel outside the active BWP(s). Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

In the present disclosure, where an article is added by translation, for example “a”, “an”, and “the”, the disclosure may include that the noun following these articles is plural.

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different”.

Each aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

The present international patent application is based on and claims priority to Japanese patent application No. 2022-165796 filed on Oct. 14, 2022, the entire contents of which are hereby incorporated herein by reference.

### DESCRIPTION OF THE REFERENCE NUMERALS

10 Base station
110 Transmission unit
120 Reception unit
130 Configuration unit
140 Control unit
20 Terminal
210 Transmission unit
220 Reception unit
230 Configuration unit
240 Control unit
1001 Processor
1002 Memory
1003 Storage
1004 Communication apparatus
1005 Input apparatus
1006 Output apparatus
2001 Vehicle
2002 Drive unit
2003 Steering unit
2004 Accelerator pedal
2005 Brake pedal
2006 Shift lever
2007 Front wheel
2008 Rear wheel
2009 Axle
2010 Electronic control unit
2012 Information service unit
2013 Communication module
2021 Current sensor
2022 Revolution sensor
2023 Pneumatic sensor
2024 Vehicle speed sensor
2025 Acceleration sensor
2026 Brake pedal sensor
2027 Shift lever sensor
2028 Object detection sensor
2029 Accelerator pedal sensor
2030 Driving support system unit
2031 Microprocessor
2032 Memory (ROM, RAM)
2033 Communication port (IO port)

1. A terminal comprising:
a reception unit configured to receive a signal related to positioning in device-to-device direct communication from a terminal in a first resource pool;
a control unit configured to perform measurement based on the signal related to positioning in the device-to-device direct communication; and
a transmission unit configured to transmit information based on the measurement to the terminal in a second resource pool, wherein
the control unit determines the first resource pool and the second resource pool.

2. The terminal as claimed in claim 1, wherein
the control unit determines the second resource pool from one or more resource pool candidates associated with the first resource pool.

3. The terminal as claimed in claim 1, wherein
the reception unit receives information related to the second resource pool from the terminal, and
the control unit determines the second resource pool based on the information.

4. The terminal as claimed in claim 1, wherein
the control unit determines the first resource pool from one or more resource pool candidates associated with the second resource pool, and
the transmission unit transmits, to the terminal, a request of transmission of the signal related to positioning in the device-to-device direct communication including information related to the first resource pool.

5. The terminal as claimed in claim 1, wherein
in a case where the reception unit receives, from the terminal, information related to the second resource pool and a request of an operation related to positioning and where the second resource pool based on the information cannot be used,
the transmission unit transmits, to the terminal, a rejection to the request of the operation.

6. A positioning method performed by a terminal, the positioning method comprising:
receiving a signal related to positioning in device-to-device direct communication from a terminal in a first resource pool;
performing measurement based on the signal related to positioning in the device-to-device direct communication;
transmitting information based on the measurement to the terminal in a second resource pool; and
determining the first resource pool and the second resource pool.
